(19) United States
(12) Patent Application Publication
(10) Pub. No.: US 2005/0239210 A1
(43) Pub. Date: Oct. 27, 2005

(54) Analytical chip and analytical apparatus

(75) Inventor: Kazuhiro Iida, Tokyo (JP)

Correspondence Address: YOUNG & THOMPSON, 745 SOUTH 23RD STREET, 2ND FLOOR, ARLINGTON, VA, 22202, US

(73) Assignee: NEC Corporation, Tokyo (JP)

(21) Appl. No.: 10/523,019

(22) PCT Filed: Aug. 4, 2003
(86) PCT No.: PCT/JP03/09855

§ 371 Date: Feb. 2, 2005

(30) Foreign Application Priority Data
Aug. 2, 2002 (JP) 2002-226750

(51) Int. Cl. G01N 21/00; G01N 21/75

(52) U.S. Cl. 436/164

(57) ABSTRACT

An analytical chip for use in the analysis of a protein, a nucleic acid or the like, includes a substrate fitted with a channel wherein a sample is introduced. In the channel, there is provided a reagent layer containing a reagent, the reagent capable of detecting the presence of specified component and capable of indicating the specified component presence through color formation or other means. A sample is introduced in the channel through a sample introduction port and is developed over the reagent layer. The state of any reaction accompanying the reagent development is magnified with a microlens and can be easily observed. By virtue of this analytical chip, not only is it unnecessary to install special external equipment for detection and analysis but also, after specimen application, analytical result can be immediately found at the very site by visual inspection.

The present invention relates to an analysis chip, in which a particular substance can be detected or a concentration of that substance can be detected, and an analyzing apparatus using it.

### BACKGROUND ART

In recent years, the research development of an analysis chip having an analyzing function such as protein, nucleic acid and the like on a chip has been vigorously carried out (Nikkei Bio-Business 2002-2 Page 25-27). A micro analyzing channel and the like are formed on those analysis chips by using a micro processing technique, and a very small quantity of sample is put on the chip. Thus, by using a dedicated automatic analyzing equipment, an analysis result can be quickly obtained.

In the analysis using a conventional analysis chip, the analysis chip in which a sample is put is fed into a facility including large external equipments having detecting functions and analyzing functions, and those large external equipments are used to analyze the analysis chip. Thus, an analysis result is obtained. For example, in a technique noted in a patent document 1, a micro chip and external equipments such as a thermal lens microscope and the like are jointly used, thereby obtaining the analysis result.

In an analysis and an inspection, there are various kinds of items. Analysis chips are formed for each of those items. In those analysis chips, the external equipments which are different for each item of the analysis and inspection are used to obtain the analysis results.

Japanese Laid Open Patent Application (JP-A 2001-4628) discloses an invention with regard to an immunity analyzing apparatus. The immunity analyzing apparatus according to the invention is characterized by including: solid particles of diameters of 1 mm or less as a reaction solid phase; a micro channel reaction bath having a vertical section area larger than the diameter of this solid particle; a micro channel separator having a vertical section area smaller than the diameter of the solid particle; and a micro chip having an introducer for separately introducing an antigen and an indication antibody to a reaction bath or micro channel inlet.

Japanese Laid Open Patent Application (JP-A-Heisei, 1-250809) discloses an apparatus that is intended to enable the easy execution of a measurement excellent in reproducibility, in a bent amount measuring apparatus of a printed wiring board which contains electronic parts or on which the electronic parts are placed.

Japanese Laid Open Patent Application (JP-A-Showa, 57-084402) discloses an optical fiber core wire terminal generator in which the coating removal and cut of an optical fiber having a coating can be carried out by using the same tool.

Japanese Laid Open Patent Application (JP-A-Showa 62-100641) discloses a particle analyzing apparatus that includes a device for measuring a flow diameter of a sample solution, in order to efficiently execute a particle analysis at a high precision, independently of a specimen particle concentration in the sample solution.

Japanese Laid Open Patent Application (JP-A 2002-116145) discloses a solution concentration measuring method that reserves a precision of a concentration measurement, by measuring an optical property of a reagent solution, when measuring a concentration of a particular component in an inspection solution.

Japanese Laid Open Patent Application (JP-A-Heisei, 09-121838) discloses an apparatus that cultures a germ targeted for a sanitation inspection of food or a biochemistry inspection, in a culture medium within a dish for a proper time and automatically measures the number of colonies which are grown to the size equal to or greater than that before the culture by at least several times. This discloses an apparatus, which in the above apparatus, further includes a CCD camera arranged at a position where the entire dish can be measured, a lens and a driver for changing the position of the lens, and enables the measurement of the entire dish and the measurement in which a part of the dish is enlarged.

Japanese Laid Open Patent Application (JP-A-Heisei, 04-136742) discloses a particle analyzing apparatus characterized in that in a flow site meter for emitting the laser light of semiconductor laser to the cell floating liquid flowing at a high speed, detecting an optical signal caused by its scattered light and fluorescence, and analyzing the characteristic and structure of the cell, the emitted laser light is stabilized.

Japanese Laid Open Patent Application (JP-A-Showa 63-241451) discloses a particle analyzing apparatus that optically divides a scattered light measuring system and an observing optical system for monitoring a shape, a position and the like of an emission beam.

### DISCLOSURE OF INVENTION

An object of the present invention is to provide an analysis chip that enables an analysis result to be visually known without any necessity of an equipment additionally having a detecting function or analyzing function.

Another object of the present invention is to provide the analysis chip that enables the analysis result to be obtained in a shorter time.

According to the analysis chip, a measurement result of data serving as a base of a diagnosis and the like can be quickly obtained, which is effectively used in a clinical site. Moreover, according to the analysis chip, without going to a dedicated facility, a person can easily know the analysis result.

According to the present invention, an analysis chip is provided which includes: a substrate on which a channel is formed; a sensing element placed in a part of the channel in order to generate a change in appearance when a particular substance flows through the channel; and a lens covering the sensing element. The change in the appearance implies, for example, color generation, light emission, color change, color loss or extinction. They are caused by a chemical change which the particular substance exhibits in the sensing element.

Since the analysis chip of the present invention has the lens to enlarge the change in the appearance of the sensing element, the visibility of the change in the appearance in the sensing element is improved. Thus, even if the sensing element is minute, the change in the appearance, such as the color generation, the light emission, the color change, the color loss or the extinction, can be accurately recognized, which can make the entire analysis chip smaller. Also, in that case, the amount of the sample necessary for the analysis can be made smaller.

Moreover, by grasping in advance the relation between the concentration of the above particular component and the above light emission or hue, the concentration of the particular component included in the sample can be known.

By the way, the lens in the present invention is the minute micro lens and implies the lens in which an image can be enlarged. A Fresnel type lens and the like are included in the micro lens.

Also, according to the present invention, in the above analysis chip, the analysis chip is provided which is molded integrally with the lens and includes a coating member for covering the channel.

According to the analysis chip, at a manufacturing step, a step of bonding the coating member and the micro lens is omitted. Also, in a case of the bonding through the adhesion by using adhesive, fusion, or supersonic wave, there may be a possibility that the refractive indexes of the coating member and the micro lens are changed on the bonding surface. The drop in the visibility in the channel may be considered. However, such anxiety is little in the analysis chip of the present invention.

Also according to the present invention, the analysis chip including a first illumination member for emitting the light to the sensing element is provided.

Since the illumination member emits the light to the sensing element, the visibility of the sensing element is improved. Thus, the accurate analysis result can be visually obtained. Moreover, since the detecting and analyzing equipment is not required, the analysis can be executed independently from the place of testing, and the analysis result can be quickly obtained.

Also according to the present invention, in the above analysis chip, the first illumination member emits ultraviolet light to the sensing element.

Also according to the present invention, in the above analysis chip, the substrate is made of the material through which visible light is transmitted, and the first illumination member emits the light from the side face of the substrate.

Also according to the present invention, in the above analysis chip, the first illumination member emits the light from the side of the bottom surface of the channel.

In the analysis chip, the bottom of the above channel is illuminated from the low surface direction of the analysis chip by the above first illumination member. Thus, the visibility of the above detection region can be improved, thereby obtaining the accurate analysis result.

Also according to the present invention, in the above analysis chip, the first illumination member is an optical guiding path.

When the light is supplied to the optical guiding path placed in the analysis chip of the present invention, the above sensing element is illuminated by indirect light leaked out from the optical guiding path. Thus, as compared with the case that the entire analysis chip is illuminated by the direct light, the image of the above sensing element can be obtained at a high state of contrast. Hence, the visibility of the above sensing element can be improved, thereby obtaining the accurate analysis result.

Also according to the present invention, in the above analysis chip, the sensing element includes a reagent in which the appearance is changed by the reaction with the particular component. The change in the appearance is, for example, the color generation, the light emission, the color change, the color loss or the extinction.

Since the analysis chip of the present invention has the reagent as mentioned above, the accurate and quick analysis can be attained.

The reagent is uniformly distributed in the sensing element.

In the analysis chip, by measuring the distance or area of the region of the color generation, light emission, color change, color loss or extinction in the above sensing element, the above particular component included in the above sample can be quantified. At this time, the quantified result can be obtained as a continuous quantity. Thus, the concentration of the above particular component in the above sample can be accurately determined.

According to the present invention, a scale is placed along the sensing element.

According to the analysis chip, by using the above scale, the reaction region in the above sensing element can be measured simply and quickly, which enables the concentration of the above particular component in the above sample to be instantly determined.

According to the present invention, the reagent in the above analysis chip includes at least one member selected from a group composed of an enzyme, an antibody, an antigen and a fluorescent material.

Since the analysis chip of the present invention has the above reagent, only the above particular component can be detected selectively and efficiently.

Also according to the present invention, an analyzing apparatus is provided which has the above analysis chip and a second illumination member emitting light to the sensing element from the side face of the analysis chip.

According to the analyzing apparatus, since the above channel is illuminated by the above second illumination member, the visibility of the above sensing element is improved. Thus, the analysis result can be obtained much accurately.

Also according to the present invention, the light which the second illumination member emits to the sensing element is the ultraviolet light.

Also according to the present invention, the second illumination member includes a light collecting lens collecting the light to the sensing element.

The analyzing apparatus of the present invention collects the light from the illumination that can be used at any time, such as solar light, lamp and the like, by using the above light collecting lens. Thus, the visibility of the above light generation, light change and light loss reaction can be easily improved without any necessity of a large apparatus.

Also according to the present invention, the second illumination member is the light emitting member. In particular, it is any of a bulb, LED and a black light.

According to the analyzing apparatus of the present invention, the assistant illumination using the usual light emitting member, for example, such as the bulb, the LED (Light Emitting Diode) and the like, enables the analysis to be executed even in the environment in which the light amount is very low, and the result can be obtained.

Also according to the present invention, an analysis chip characterized by including: a substrate where a channel through which a sample passes is placed; an introduction port to introduce the sample into the channel; a reactor which is placed on a downstream side from the introduction port of the channel and in which an indication substance to be specifically coupled to a particular component is placed; and a catcher, which is placed on a downstream side from the reactor of the channel, for catching the indication substance coupled to the particular component is provided. According to this analysis chip, the particular component can be simply detected by confirming the fact that the indication substance coupled to the particular component is caught by the catcher.

Also according to the present invention, the analysis chip characterized in that in the above analysis chip, the width of the channel of the region where the catcher of the channel is placed is gradually narrowed toward the advancement direction of the channel is provided.

Also according to the present invention, the analysis chip characterized in that in the above analysis chip, the density of the indication substance in the catcher is higher toward the downstream side of the channel is provided. According to those analysis chips, in addition to the detection of the above particular component, the execution of the quantitative analysis becomes also possible.

Also according to the present invention, the analysis chip including: a substrate on which a channel gradually narrowed toward the downstream side is formed; and a hydro-gel layer, which is placed along the wall surface of the channel and closes the channel at a different position depending on the amount of the particular component by swelling when the particular component is absorbed is provided.

Also according to the present invention, the analysis chip including: the substrate on which the channel gradually narrowed toward the downstream side is formed; and the hydro-gel layer, in which the channel is closed at a predetermined initial close position, and the contraction resulting from the absorption of the particular component causes the position, where the channel is closed, to move to the downstream side from the initial close position is provided.

Also according to the present invention, the analysis chip including: the substrate on which the channel gradually narrowed toward the downstream side is formed; and a bead placed in the channel and whose surface is formed by hydro-gel layer whose volume is changed when absorbing the particular component is provided. When liquid flows through the channel, the bead is carried away by the liquid and stopped at a different position in the channel depending on the volume.

Also according to the present invention, the analysis chip including: s substrate on which a channel is formed; a polymer solution placed inside the channel in which the reaction with a particular substance changes a viscosity; a target bead placed inside the channel; and a tentative holder that is placed at a predetermined position inside the channel and holds the target bead at a predetermined position when a force weaker than a predetermined magnitude is applied to the target bead is provided.

In the analysis chip, the target bead may be a ferromagnetic material. When a magnet having a certain magnetic force is made close to the analysis chip, the target bead is moved in the channel at a different speed depending on the viscosity of the polymer solution. By measuring the movement speed, the amount of the particular substance can be quantitatively measured.

The analysis chip may further include: a pair of electrodes placed at ends of the channel; and a battery for generating a potential difference between the pair of electrodes, and the surface of the target bead is charged in a solution of a predetermined pH. According to the analysis chip, the generation of the potential difference between the pair of electrodes causes the target bead to be moved at a different speed depending on the viscosity of the polymer solution. By measuring the movement speed, the amount of the particular substance can be quantitatively measured.

Also according to the present invention, an analysis chip including: a substrate on which a channel is formed; a solution holder that is placed in the channel and contains a solution through capillary attraction; an introduction path to introduce the solution into the solution holder through the capillary attraction; and a sensing element that is placed at a part of the channel and induces a change in appearance when a particular substance flows through the channel is provided.

According to the analysis chip, without any usage of a different tool to measure the amount of the solution, the predetermined amount of a sample of an inspection target can be held inside the analysis chip.

Also according to the present invention, an analysis chip including: a substrate on which a first channel and a second channel are formed; a first solution holder placed in the first channel; and a second solution holder placed in the second channel is provided. In the analysis chip, the first solution holder holds a solution of a first predetermined amount through the capillary attraction. The second solution holder holds a solution of a second predetermined amount different from the first predetermined amount through the capillary attraction. Numerals corresponding to the first predetermined amount and the second predetermined amount are preferably displayed on the substrate.

Also according to the present invention, an analysis chip is provided in which a channel is a rectangular groove formed on a surface side of a substrate and this includes a reflector that is placed along a bottom surface of the substrate and reflects a visible light. According to the analysis chip, due to the difference between a refractive index of the substrate and a refractive index of a substance filled in the channel, when it is viewed from a proper angle, a portion where a solution is prepared seems to be bright because of a reflection light of a foil, and the other portion seems to be dark. In the analysis chip, the portion where the solution is prepared is easily measured by a visual inspection.

Also in the analysis chip of the present invention, the wall surface of the channel is covered with a material whose refractive index is equal to or less than a refractive index of water. According to the analysis chip, the solution filled in the channel has a relation of a refractive index of a core of an optical fiber, and the channel has a relation of a refractive index of a clad. Depending on a direction of an observation of the channel, total reflection occurs on a boundary between the surface of the channel and the water solution. Thus, the channel portion of the water solution seems to be bright as compared with the non-existence portion. In the analysis chip, the portion where the solution is prepared can be easily measured by the visual inspection.

Also, an analysis chip according to the present invention includes: a substrate on which a channel is formed; and a transparent cover for covering the channel. A distance between a bottom surface of the channel and the cover is continuously changed in an extension direction of the channel. The interference band whose position is different depending on a refractive index of the substance filled in said channel is displayed on the outer side of the cover by reflection of light between the bottom surface and the cover. By observing the interference band, the information with regard to the refractive index of the substance filled in the channel is easily obtained by the visible inspection.

### BRIEF DESCRIPTION OF DRAWINGS

FIG. 1A to FIG. 1C are views showing an analysis chip of the present invention.

FIG. 2A to FIG. 2C are views showing an analysis chip of the present invention.

FIG. 3A to FIG. 3C are views showing an analysis chip of the present invention.

FIG. 4A to FIG. 4C are views enlarging a vicinity of a reagent layer of the analysis chip of the present invention.

FIG. 5A to FIG. 5B are views explaining a case when light is emitted to the analysis chip of the present invention.

FIG. 6 is a view explaining a case when a light collecting lens is arranged on a side of the analysis chip of the present invention.

FIG. 7A to FIG. 7B are views explaining a case when a light source is arranged on the side of the analysis chip of the present invention.

FIG. 8A to FIG. 8C are views showing an analysis chip of the present invention.

FIG. 9A to FIG. 9C are views showing an analysis chip of the present invention.

FIG. 10A to FIG. 10B are views explaining a method of filling a dry reagent bead in a channel.

FIG. 11 is a view showing an analysis chip of the present invention.

FIG. 12 is a view explaining a separation region of FIG. 11.

FIG. 13A and FIG. 13B are views showing an analysis chip of the present invention.

FIG. 14A and FIG. 14B are views explaining a detecting method that uses the analysis chip of the present invention.

FIG. 15 is a view showing an analysis chip of the present invention.

FIG. 16 is a view explaining a principle in which a latex bead is captured on an inner wall of a detector.

FIG. 17A and FIG. 17B are views explaining a quantifying method that uses the analysis chip of the present invention.

FIG. 18A and FIG. 18B are views explaining a quantifying method that uses the analysis chip of the present invention.

FIG. 19A and FIG. 19B are views showing an analysis chip according to the present invention.

FIG. 20A and FIG. 20B are views showing an analysis chip according to the present invention.

FIG. 21A to FIG. 21C are views showing an analysis chip according to the present invention.

FIG. 22A and FIG. 22B are views showing an analysis chip according to the present invention.

FIG. 23 shows a wiring of a battery used in the present invention.

FIG. 24 shows a relation between a kind of a substituent, pH and an electrified charge.

FIG. 25A to FIG. 25C are views showing an analysis chip according to the present invention.

FIG. 26A to FIG. 26C are views showing an analysis chip according to the present invention.

FIG. 27A and FIG. 27B are views showing an analysis chip according to the present invention.

### BEST MODE FOR CARRYING OUT THE INVENTION

The best mode embodiments for carrying out the present invention will be described below with reference to the drawings.

### First Embodiment

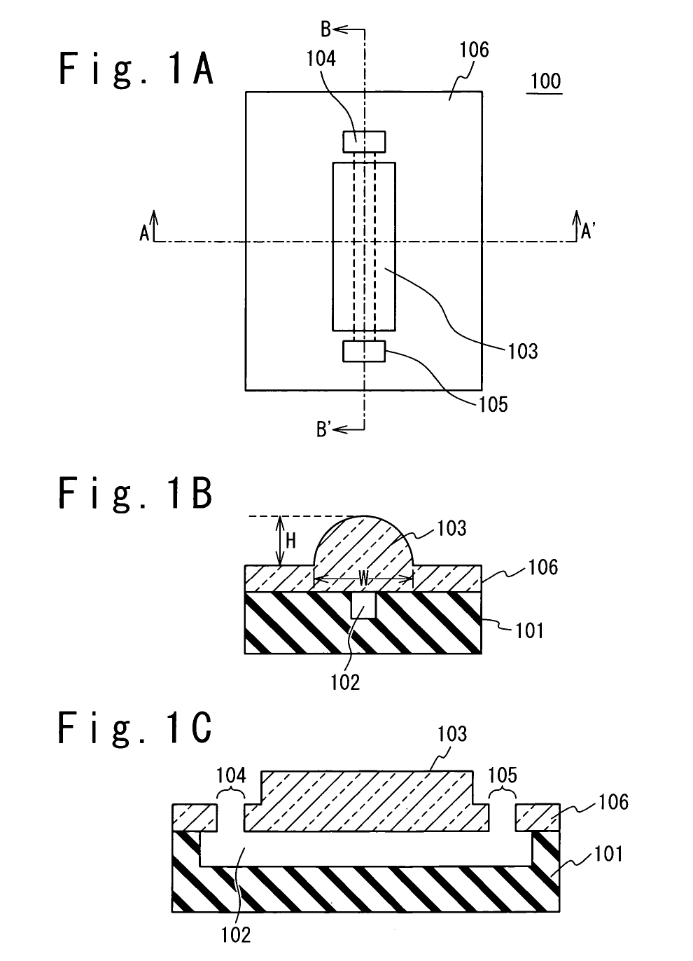

FIG. 1A is a top view of an analysis chip 100 according to this embodiment. Also, FIG. 1B and FIG. 1C show an A-A′ sectional view and B-B′ sectional view in FIG. 1A, respectively.

In the analysis chip 100, a transparent coating 106 is formed on a substrate 101 in which a channel 102 is placed, and a micro lens 103 is further placed on the coating 106. Also, a sample introduction port 104 to introduce a sample of an analysis target into the channel 102 and an exhaust port 105 to enable air in the channel 102 to be exhausted when the analysis sample is introduced are placed in the coating 106.

A using method of the analysis chip 100 will be described below. The sample of the analysis target is injected from the sample introduction port 104 and spread into the channel 102 by a capillary effect or press-fitting in which a pump is used or the like. The channel 102 includes a substance or reagent whose mutual action with a particular component contained in the sample of the analysis target results in color generation, light emission, color change, color loss or extinction. Consequently, the particular component can be detected in the channel 102. Also, a concentration of the particular component contained in the sample can be known as will be described later.

Since the micro lens 103 is placed in the analysis chip 100, the appearance in the channel 102 is enlarged and observed. Thus, the color generation, light emission, color change, color loss or extinction in the channel 102 can be recognized in detail. Moreover, even if the channel 102 is very thin, the color generation, light emission, color change, color loss or extinction can be recognized. In order to visually observe the appearance in the channel 102 through the micro lens 103, the width of the channel 102 may be about 10 μm to about 100 μm. In this way, since the channel 102 can be thin, in the analysis based on the analysis chip 100, the amount of the sample to be provided to the analysis can be made smaller. Also, the channels may be plural. In this case, since the channel is thin, many channels can be integrated. Thus, in one analysis chip, the analysis related to many items can be carried out at the same time. By the way, if the micro lens 103 is not used, in order to visually observe the appearance in the channel 102, the width of the channel 102 is preferred to be about 50 μm to 1 μm.

Here, as the coating 106, the entirely transparent coating may be used as mentioned above. However, the coating in which only the region located above the channel 102 when it is bonded to the substrate 101 is transparent may be employed. In this case, since the stray light from the portion except the channel 102 is shielded, the visibility in the channel 102 is improved.

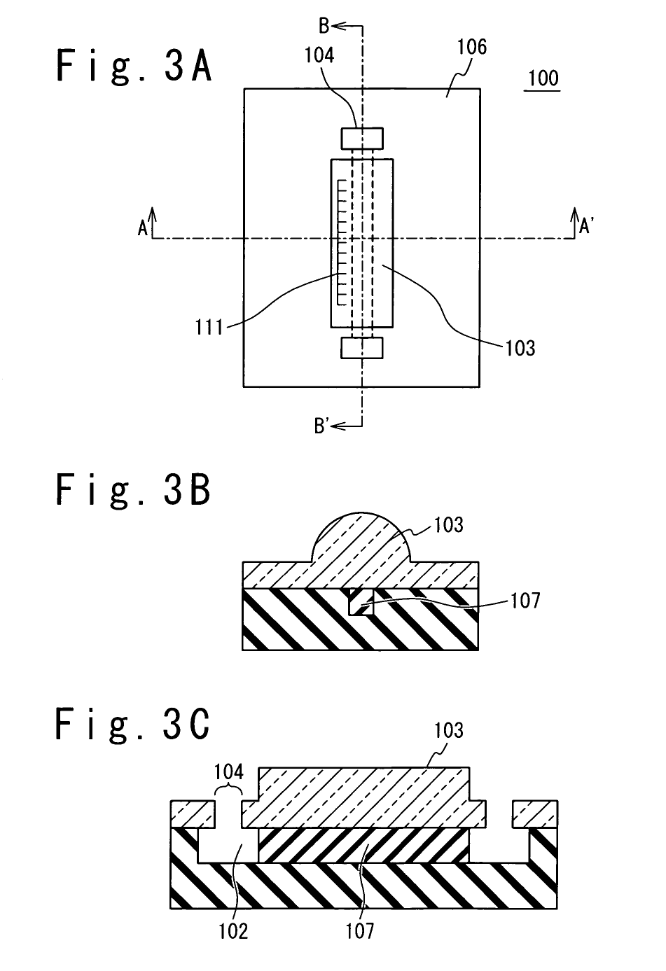

A reagent layer 107 containing a reagent whose mutual action with the above particular component generates color is placed in the channel 102 of the analysis chip 100, as shown in FIG. 3. FIG. 3A shows the top view of the analysis chip 100, and the A-A′ sectional view and B-B′ sectional view in FIG. 3A are FIG. 3B and FIG. 3C, respectively. As shown in FIG. 3B and FIG. 3C, the reagent layer 107 is filled in the channel 102. Then, when a sample of an analysis target is injected from the sample introduction port 104, the sample is dispersed into the reagent layer 107.

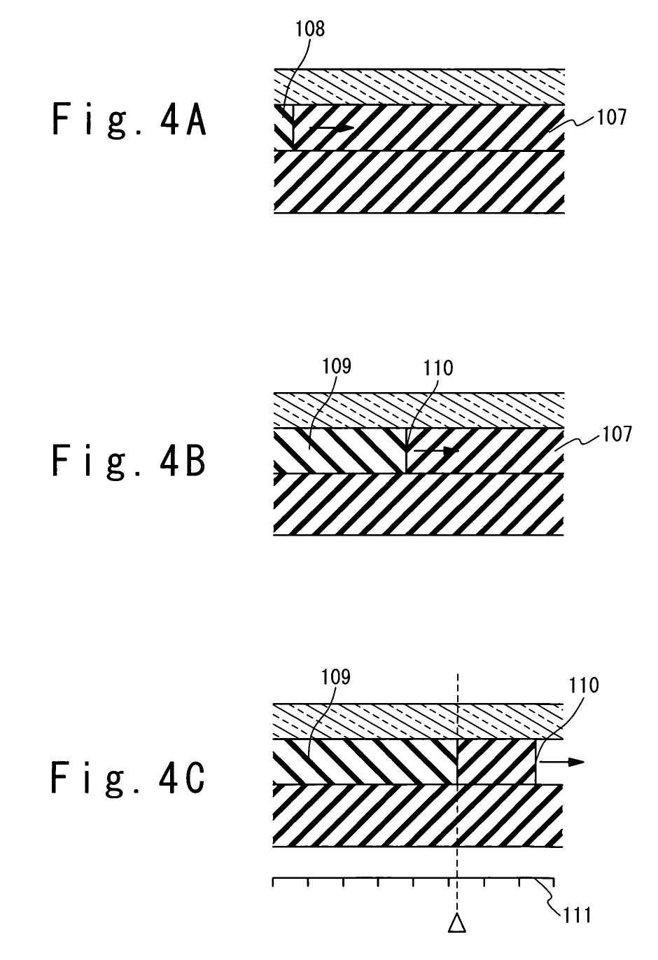

The operation in the permeation of the above sample into the reagent layer 107 will be described below with reference to FIG. 4. In FIG. 4, the vicinity of the reagent layer 107 in FIG. 3 is enlarged and shown. FIG. 4A shows the state immediately after a sample 108 arrives at the left end of the reagent layer 107. From this state, the sample 108 is developed to the direction of an arrow in FIG. 4A, with the elapse of time. FIG. 4B shows the state when a certain time elapses from the state of FIG. 4A. As the result that the sample is developed in the reagent layer 107, a sample boundary 110 arrives at the middle of the reagent layer 107. Then, in the region from the left end of the reagent layer 107 to the sample boundary 110, the particular component contained in the sample and the reagent contained in the reagent layer 107 absorb and react, which consequently forms a color generation region 109. FIG. 4C shows the state when a time further elapses from the state of FIG. 4B. Although the sample boundary 110 is moved to the right side from the state of FIG. 4B, the right end of the color generation region 109 is not coincident with the sample boundary 110, and it remains in a dotted line of the drawing. This is because when the sample boundary 110 arrives at the dotted line, all of the particular components contained in the sample absorb to the reagent in the reagent layer 107, which leads to the complete reaction. Thus, the color is not generated in the right region from the dotted line.

Moreover, in this embodiment, since the reagent layer 107 contains a reagent of a certain amount per unit volume and then a distance when the color generation region 109 is developed in aright side is measured, the particular component contained in the sample can be quantified. For example, in FIG. 4C, the distance from the left end of the reagent layer 107 to the right end of the color generation region 109 can be visually known by using a scale 111. By the way, the scale 111 is printed on the coating 106, actually, for example, as shown in FIG. 3A. Then, through the micro lens 103, in the state that the reagent layer 107 and the scale 111 are enlarged, they can be recognized at the same time. Here, the scale 111 is not limited to the shape as arranged in FIG. 3A. For example, it can be placed along the micro lens 103 on the coating 106.

As mentioned above, according to the analysis chip in this embodiment, the quantitative analysis of the particular component can be quickly executed without any usage of the other analyzing equipments.

Although the analysis chip in this embodiment can be applied to the operation for detecting and quantifying various substances, the applications to: the blood biochemistry inspection of glucose, alanine aminotransferase, albumin, alkali phosphatase, amylase, calcium ion, total cholesterol, lipoperoxide, creatinine, potassium ion, bilirubin, total protein and the like; the immunity serologic inspection of Hbs antigen and antibody, HCV antigen and antibody, HIV antibody and the like; and the tumor marker of CEA, CA19-9, PSA, CA-125 and the like are exemplified.

For example, in the case of quantifying the glucose, as the reagent layer 107, the mixture particle of glucose oxidase, peroxidase, 4-aminoantipyrine, and N-ethyl-N-(2-hydroxy-3-sulfopropyl)-m-toluidine sodium, or the dry reagent bead containing them is used, and the region of the color generation is measured. Consequently, it can be measured. The principle in this case is as follows. When the glucose of one molecule is shifted into the above reagent bead gelled by absorbing water, it is decomposed into gluconic acid of one molecule and hydrogen peroxide of one molecule by the action of the glucose oxidase. Next, inside the reagent bead, this hydrogen peroxide reacts with the 4-aminoantipyrine of one molecule, and the N-ethyl-N-(2-hydroxy-3-sulfopropyl)-m-toluidine sodium of one molecule, respectively, by the action of the peroxidase, and chinone-based dye is generated and reddish purple comes out. In short, the existence of the glucose of one molecule is detected by the generation of the chinone-based dye of one molecule. Thus, by setting the particle content per unit volume of the reagent layer 107 constant, it is possible to set the glucose detection amount per unit volume of the reagent layer 107 and measure the absolute amount of the glucose in the specimen. Hence, it is possible to determine the glucose concentration of the specimen.

By the way, the above dry reagent bead can be produced as described below. At first, as a binder, the sol containing water absorbing polymer such as agarose, poly-acryl-amide, methyl cellulose and the like is prepared. The sol is gelled naturally with time. This sol and the predetermined amount of the glucose oxidase, peroxidase, 4-aminoantipyrine and N-ethyl-N-(2-hydroxy-3-sulfopropyl)-m-toluidine sodium are mixed. The thus-obtained sol is sprayed into dry air and made into droplet. Since this droplet is dried while gelled during the dropping, the intended dry reagent bead can be obtained.

Also, as the producing method of the above dry reagent bead, the following method can be also employed. On the surface of a flask or the like, after the sol containing the above reagent is gelled, vacuum freezing dry is performed. As a result, the solid matter having many holes is obtained. This solid matter can be easily crashed and made into the bead or powder.

Here, it is possible to employ the dry reagent bead having a three-layer structure, namely, the dry reagent bead composed of: the core portion containing the glucose oxidase; the layer containing peroxidase formed so as to cover the surface of this core portion; and the layer containing the 4-aminoantipyrine and N-ethyl-N-(2-hydroxy-3-sulfopropyl)-m-toluidine sodium formed so as to cover that layer. In that kind of dry reagent bead, the hydrogen peroxide is generated in the core portion in which the glucose oxidase exists, and it is instantly exhausted as it is shifted to the layer containing the peroxidase covering the core portion. Thus, the hydrogen peroxide is hard to flow out from the bead. Hence, this has little influence on the color generation of the other dry reagent beads. Hence, this has the merit that the accurate detection and measurement can be executed.

In the dry reagent bead having the above three-layer structure, the material in which the glucose oxidase is mixed with the above sol is used as raw material, and the core portion is produced by a fluidized bed particle producing method. After that, the surface of this core portion is coated with the material in which the peroxidase is mixed with the sol by using the fluidized bed particle producing method. Next, it is coated with the material in which the 4-aminoantipyrine and N-ethyl-N-(2-hydroxy-3-sulfopropyl)-m-toluidine sodium is mixed with sol, and the intended dry reagent bead can be obtained. By the way, for example, the dry reagent bead can be produced, for example, by using AGROMASTER (a registered trademark) AGM-SD that is the fluidized bed particle producing apparatus made by Hosokawa Micron Corporation.

Also, in order to detect the HCV antibody in the sample, for example, a solid layer immunity quantifying method or an ELISA method (Enzyme-Linked immuno-sorbent Assay) can be used. In this case, for example, the core protein that is the structure protein of HCV is deposited on the bottom surface of the channel 102 (FIG. 1). Concretely, when poly-stylene is employed as a material in the substrate 101, by introducing into the channel 102 the material in which the core protein is dispersed into a buffer, the core protein can be easily deposited on the bottom surface of the channel 102. After that, if the HCV antibody for recognizing the core protein is included in the sample, the antibody couples to the above core protein, and an antibody—antigen composite is generated. Next, by introducing the buffer from the sample introduction port 104 and circulating the buffer within the channel 102, the inside of the channel 102 is washed. Then, a polyclonal antigen (second antigen) for recognizing the above HCV antigen is introduced into the channel 102, and the second antigen is further coupled to the above antibody—antigen composite, and the inside of the channel 102 is washed similarly to the above case. At this time, by coupling a fluorescence indicator or an enzyme such as alkali phosphatase and the like to the second antibody, the high sensibility detection of the HCV antibody is realized. If the fluorescence indicator is coupled to the second antibody, by emitting a black light or the like to the inside of the channel 102, the existence of the HCV antibody can be recognized. On the other hand, if the alkali phosphatase is coupled to the second antibody, when a color generation substance such as p-nitro-phenyl-phosphate and the like is introduced into the channel 102, the enzyme reaction of the alkali phosphatase occurs, which leads to the color generation. Thus, the HCV antibody can be detected.

In the above explanation, the detection of the antibody included in the sample has been described by using the example of the HCV antibody. However, in order to detect the particular protein in the sample, for example, the core protein that is the structure protein of HCV, the following method can be also employed. A monoclonal antibody (first antibody) for recognizing a region of an N end of the core protein that is the structure protein of HCV is coupled to the bottom surface of the channel 102 (FIG. 1). The sample is introduced from the sample introduction port 104 and moved to the channel 102 by the capillary effect. If the sample includes the above core protein, the first antibody and the core protein constitute the antibody—antigen composite. Next, the inside of the channel 102 is washed similarly to the above case. Then, the monoclonal antibody (second antibody) for recognizing the region except the N end of the above core protein is introduced into the channel 102, and the second antibody is further coupled to the above antibody—antigen composite, and the inside of the channel 102 is again washed similarly to the above case. At this time, by coupling the fluorescence indicator or the enzyme of the alkali phosphatase and the like to the second antibody, the method similar to the case of the above HCV antibody is used to enable the high sensibility detection even with regard to the HCV antigen.

In the above method, although the washing steps of the channel is inevitable, the following method is exemplified as the method that does not require the washing. This method uses the analysis chip configured such that a reactor where an indicator substance specifically coupled to the particular component in a sample is placed on the downstream side of a sample introduction port, and a catcher for catching the indicator substance coupled to the particular component is further placed on this downstream side. Here, the case of detecting the HCV antibody is explained as an example.

An analysis chip 700 shown in FIG. 15 is configured such that a sample introduction port 702, a reacting room 703 and a detection port 704 are placed on a substrate 701, and they are linked through a channel 705 as shown in the drawing. Also, colored latex bead is filled in the reacting room 703, and core protein of HCV is coated on the surface. Moreover, a detector 706 is formed in the channel 705 of the reacting room 703 and detection port 704, and a second antibody which can recognize the HCV antibody is fixed on the inner wall of this detector 706.

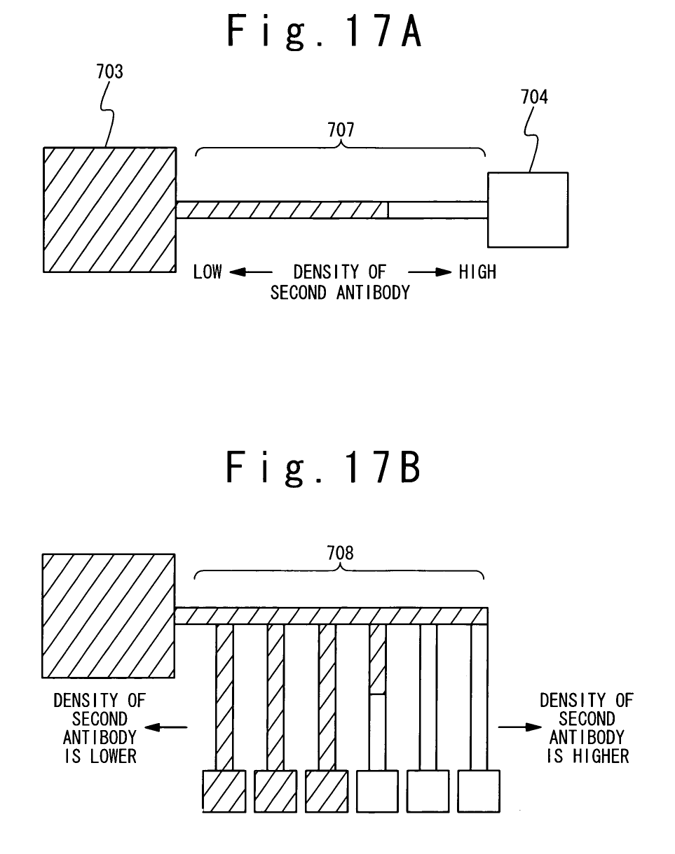

By the way, in this case, the HCV antibody corresponds to the above particular component, and the latex bead in which the HCV core protein is coated on the surface corresponds to the above indicator substance coupled to the above particular component. Also, the detector 706 and a detecting tube 707 which will be described later (FIG. 17) correspond to the catcher for catching the above indicator substance coupled to the above particular component.

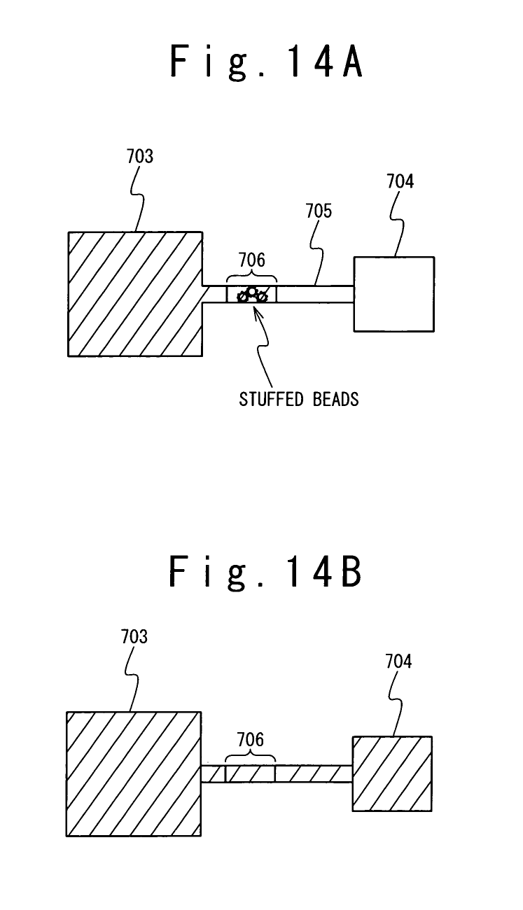

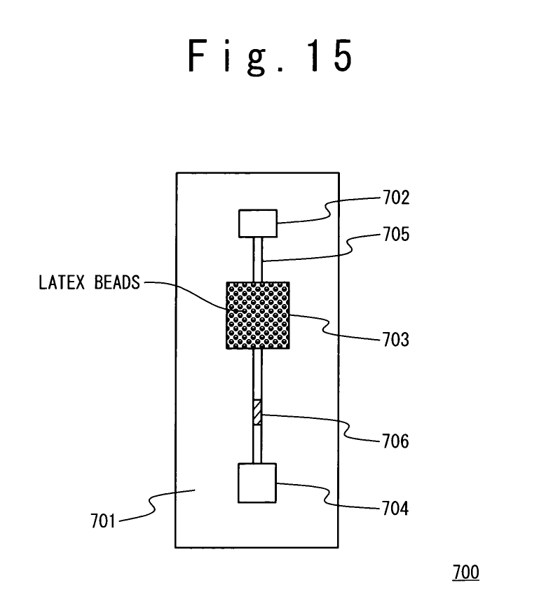

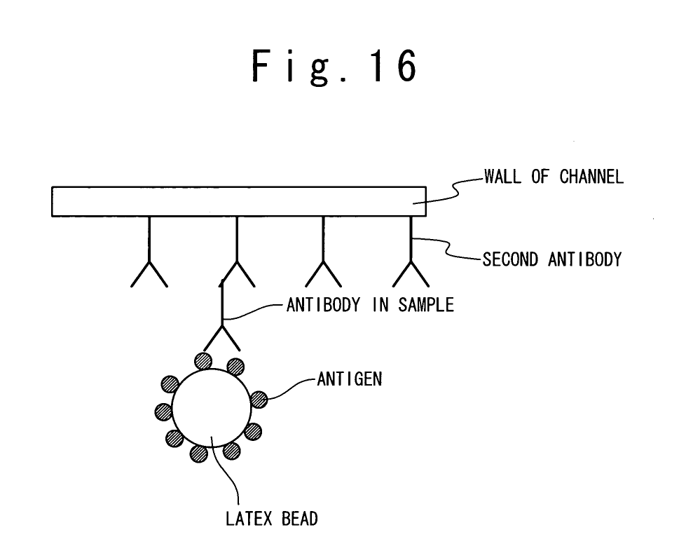

The operation and mechanism of the detection of the HCV antibody using the analysis chip 700 will be described below. At first, the sample is injected from the sample introduction port 702 and sent to the reacting room 703 by the capillary effect, the press-fitting and the like. In the reacting room 703, the sample and the latex bead in the reacting room 703 are mixed. If the HCV antibody is included in the sample, the HCV antibody is coupled to the core protein of HCV coated on the latex bead surface in the reacting room 703. Thus, the antibody—antigen composite is formed on the latex bead surface. After a while, the latex bead having this antibody—antigen composite on the surface begins to overflow from the reacting room 703 to the direction of the detection port 704 and moves to the detector 706. However, as mentioned above, since the second antibody is placed on the inner wall of the detector 706, the latex bead is caught through the HCV antibody as shown in FIG. 16. In this way, when a plurality of latex beads are caught on the inner wall of the detector 706 (FIG. 15), as shown in FIG. 14A, the channel 705 is clogged in the portion of the detector 706. Thus, although the regions from the reacting room 703 to the detector 706 are colored, the colorization is not recognized with regard to the regions from the detector 706 to the detection port 704. On the other hand, if the HCV antibody does not exist in the sample, the catching of the latex bead in the detector 706 does not occur. Hence, the latex bead can pass through the detector 706, and all of the regions from the reacting room 703 to the detection port 704 are colored as shown in FIG. 14B. In short, whether or not the HCV antibody exists in the above sample can be judged in accordance with the presence or absence of the colorization of the regions from the detector 706 to the detection port 704.

Also, instead of the detector 706 in FIG. 15, the detecting tube 707 can be employed between the reacting room 703 and the detection port 704, as shown in FIG. 17A. In the detecting tube 707, the second antibody is coated on the inner surface at a predetermined density slope. From the reacting room 703 to the detection port 704, the density of the second antibody is correspondingly increased. Employing this configuration, the HCV antibody concentration in the sample can be measured. The mechanism will be described below. The absorption force when the latex bead having the antibody—antigen composite on the surface is absorbed on the inner surface of the detecting tube 707 is related to the density of the HCV antibody coupled to the latex bead and the density of the inner wall of the detecting tube 707. For example, if the HCV antibody concentration in the sample is high, many HCV antibodies are coupled to the latex bead. Thus, in the region where the density of the second antibody is low, the absorption of the latex bead occurs which brings about the blockage of the channel. On the contrary, if the concentration of the HCV antibody in the sample is low, the HCV antibody coupled to the latex bead is a few. Thus, in the region where the density of the second antibody is low, the coupling between the HCV antibody and the second antibody is hard to occur. Hence, the latex bead is moved and absorbed to the high concentration side of the detecting tube 707. In this way, depending on the HCV antibody concentration in the sample, the position where the latex bead is absorbed on the inner wall of the detecting tube 707 is different. Hence, for example, as shown in FIG. 17A, the colorization is recognized from the reacting room 703 to the absorbed position. Hence, the HCV concentration in the sample can be known from the length of the colored region.

Instead of the detecting tube 707 of FIG. 17A, even if the configuration having a plurality of detection tubes 708 is employed as shown in FIG. 17B, the HCV antibody can be quantified similarly to the above case. In this case, the density of the second antibody to be coated on the inner wall is sequentially set to be high, for example, from the left detection tube 708 of the drawing. Thus, based on the above mechanism, the clogging occurs in the detection tube 708 where the second antibody of a certain density or more is coated on the inner wall. The detection tubes 708 where the clogging occurs are colored partially or not colored at all such as the fourth to sixth detection tubes 708 from the left side in the drawing. In the case of FIG. 17B, the tube where the absorption begins to occur can be judged as the fourth detection tube 708. Hence, the HCV antibody concentration in the sample can be estimated in accordance with this fact.

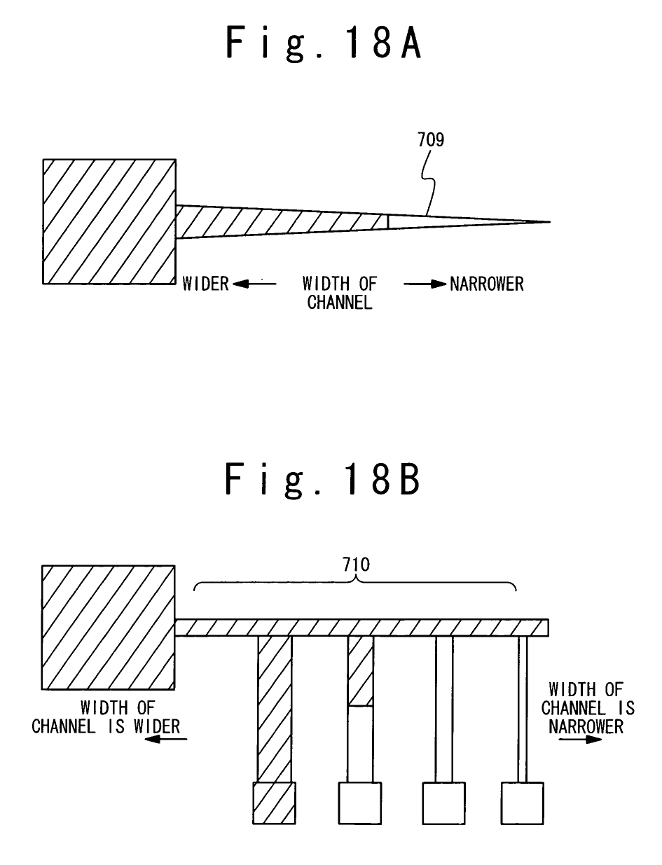

Also, the clogging easiness of the latex bead is related to the width of the channel as well as the absorption force to the inner wall of the channel. So, the HCV concentration in the sample can be determined, for example, even by employing the configuration having a detection tube 709 whose width is gradually narrowed as shown in FIG. 18A or the configuration having a plurality of detection tubes 710 whose widths are different as shown in FIG. 18B. That is, if the HCV antibody concentration in the sample is relatively high, the amount of the latex bead in which the HCV antibody is coupled onto the surface is great. Thus, even if the channel width of the detection tube is wide, the absorption of the amount enough to induce the clogging in the channel is generated. On the other hand, if the HCV antibody concentration of the sample is low, the amount of the latex bead in which the HCV antibody is coupled onto the surface is a little. Hence, the clogging is hard to occur in the position where the channel width is wide, and the clogging occurs in the downstream position where the channel width is narrow. The HCV antibody concentration can be estimated even by using this fact.

In the above case, the detection of the antibody has been described by exemplifying the HCV antibody. However, this can be applied to even the detection of the antigen. In this case, this can be attained by coating the monoclonal antibody for recognizing the particular region of the antigen of the detection target on the latex bead, and fixing the monoclonal antibody for recognizing a different region of the antigen in the detector or detecting tube.

Also, with regard to the tumor marker of CEA, PSA and the like, it can be detected and quantified by using the above-explained fixed layer immunity quantifying method or ELISA method or the method of using the latex bead. Moreover, by applying the above method to hCG (chorionic gonadotrophic hormone) in urine, the analysis chip can be obtained in which the symptom of pregnancy can be judged. Also, by applying the above method to the antibody to an abnormal prion (PrPSc) or the antibody to β amyloid or p97 protein, the analysis chips are attained which are suitable for the quick diagnoses of bovine spongiform encephalopathy and Alzheimer's disease, respectively.

As the material of the substrate 101 (FIG. 1) of the analysis chip 100 in this embodiment, the plastic material such as PMMA (poly-methyl methacrylate), PET (polyethylene terephthalate), PC (poly-carbonate), and glass and silicon substrate are exemplified. The size of the substrate 101 is not especially limited. For example, both of the longitudinal and lateral lengths may be 2 to 3 cm. Also the thickness is not especially limited. For example, it may be 0.2 to 0.7 cm. Also, the channel 102 can be formed by the known method suitable for the material of the substrate 101, for example, by the etching or the molding based on the injection molding or the like. Also, the substrate 101 having the channel 102 can be produced as follows. The die from which the channel 102 of a micro meter order can be formed is produced by a precise processing machine (for example, FANUC ROBOnanoUi (made by Fanuc Corporation), and this die and the high precision injection molding machine (for example, FANUC ROBOSHOT α−50iAP (made by Fanuc Corporation) are used to carry out the plastic injection molding. Thus, the substrate 101 can be mass-produced at the high precision.

Also, a hydrophilic process may be performed on the inner wall of the channel 102 for the sake of the easy pass of the sample. The hydrophilic process can be carried out by using the substance having the structure similar to phospholipid, for example, the water-soluble polymer (LIPIDURE (registered trademark made by NOF CORPORATION)) in which 2-methacryloil oxethl phosphoryl chloline is a configuration unit. In this case, in such a way that the LIPIDURE (registered trademark) becomes, for example, 0.5 wt %, it is dissolved in a buffer solution such as a TBE buffer (89 mM, Tris, 89 mM boric acid, 2 mM EDTA) and the like. By filling this solution in the channel 102 and leaving for several minutes, and then removing the liquid with an air gun and the like and drying it, the hydrophilic process can be performed on the inner wall of the channel 102. Also, the size of the channel 102 is not especially limited. For example, the width may be 50 to 200 μm, and the depth may be 50 to 500 μm.

The coating 106 and the micro lens 103 can be produced separately from each other, and both of them can be then press-fitted through adhesion, fusion and supersonic wave. However, both of them are preferred to be integrally molded. The integral molding enables the omission of the step of bonding the coating 106 and the micro lens 103. Also, in the case of the bonding through the adhesive, fusion or supersonic wave, the refractive indexes of the coating 106 and the micro lens 103 may be possibly changed on the bonding surface. Thus, the visibility in the channel 102 may be considered to be dropped. However, according to the integral molding, such possibility is little.

As the materials of the coating 106 and micro lens 103, the transparent materials, for example, the plastic material such as PMMA, PET and PC, and the glass and the like, are selected so as to be able to observe the channel 102. As the size of the micro lens 103, in FIG. 1B, for example, H can be 0.25 mm to 11.0 mm, and W can be 0.50 to 2.0 mm.

The bonding between the coating 106 and the substrate 101 can be carried out by using the adhesive suitable for them. Also, they may be bonded by the fusion, the press-fitting through the supersonic wave, or the engagement. In the case of using the adhesive, in order to prevent the adhesive from entering the channel 102, the adhesive is preferably coated on the position away from the channel 102, for example, on the circumferential portion of the substrate 101. In this case, extremely micro gap occurs between the channel 102 and the coating 106. However, by employing the hydrophobic substance, for example, such as silicon rubber film, as the material of the coating 106, or by performing the hydrophobic processing on the lower surface of the coating 106, for example, by using silicon coating agent and the like, it is possible to perfectly protect the water from leaking out from the channel 102.

From the viewpoint of strengthening the bonding between the coating 106 and the substrate 101, both of the materials are preferred to be equal. Also, from the viewpoint of making the weight of the analysis chip 100 lighter, the plastic material is preferably selected as the materials of the coating 106 and the substrate 101. Among the plastic materials, the PMMA is preferably selected. This is because the PMMA has the excellent transparency and strength.

The reagent layer 107 in FIG. 3 can be formed by dissolving and uniformly suspending, for example, the reagent and the binder in solvent, and pouring the solution or suspension into the channel 102, and then drying under dry nitrogen gas or dry argon gas atmosphere. Also, if the above dry reagent bead is used, the reagent layer 107 can be formed, for example, as follows. In the state that the coating 106 is not bonded, the mixture of the dry reagent bead, binder and water is poured into the channel 102. At this time, a first blocking member is placed in the channel 102 so that the mixture does not flow out into a region except a region where the reagent layer 107 is formed. In this state, the reagent layer 107 can be formed by drying and solidifying the mixture. As the above binder, for example, the sol containing the hydrophilic polymer such as agarose gel, poly-acryl amide gel and the like is exemplified. By using the sol containing those hydrophilic polymers, it is naturally gelled. Thus, the drying is not required. By the way, the reagent layer 107 may be formed so as to block the channel as shown in FIG. 3B or may be formed in the shape of a thin layer on the channel bottom surface.

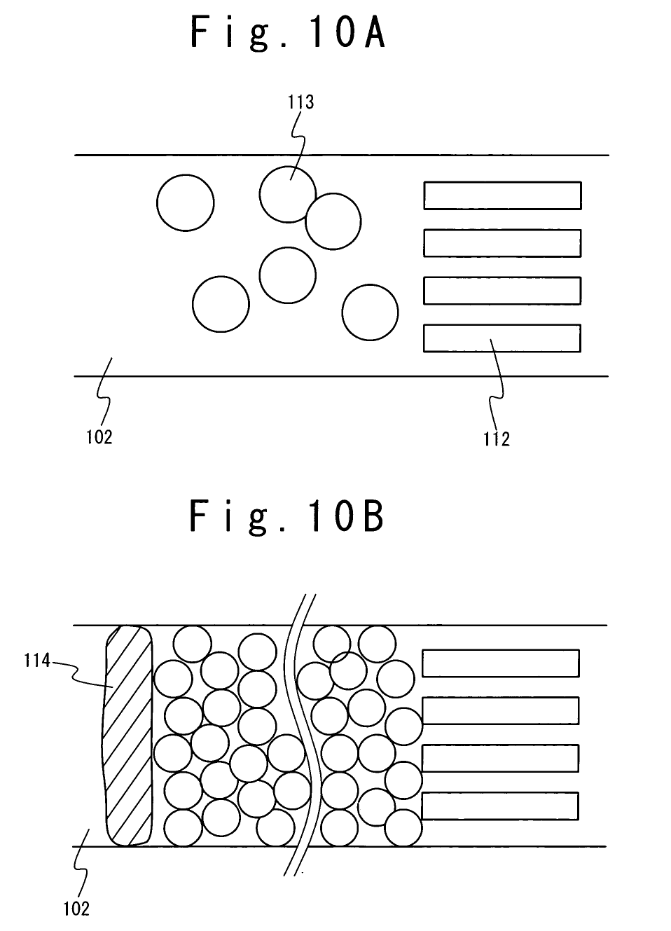

In the above explanation, the method of using the binder and forming the reagent layer 107 has been described. However, it is possible to fill the dry reagent bead in the channel by using the above dry reagent bead suspended in only water, without using the binder. For example, as shown in FIG. 10A, a first blocking member 112 is placed in the channel 102, and the capillary effect is used to pour the dry reagent bead suspended in the water into the channel 102. Thus, the water is passed through the first blocking member 112. On the other hand, since a dry reagent bead 113 is blocked by the first blocking member 112, it is filled in the channel 102 as shown in FIG. 10B. In this way, after the dry reagent bead 113 is filled, while a second blocking member 114 is used to protect the backflow of the filled dry reagent bead 113, it is dried under the dry nitrogen gas or dry argon gas atmosphere and made into the reagent layer 107 (FIG. 3). By the way, as the second blocking member 114, for example, a dry bead of gel (for example, poly-methyl cellulose), which is swelled by the buffer and exhibits the adherence, is exemplified. When this dry bead is used to form the second blocking member 114, after the dry reagent bead 113 is filled as mentioned above, the dry bead dispersed into the buffer is filled. The filled dry beads are absorbed to each other or absorbed to the inner wall of the channel 102, thereby supporting the dry reagent bead 113. By the way, in order to effectively fill the dry bead in the channel 102, the usage of the bead that is sufficiently compressed and dried is preferred. Hence, since the time required to swell the dry bead becomes long, the second blocking member can be surely formed.

Although the reagent layer 107 is filled to arrive at the coating 106 in FIG. 3, it is not the necessarily required. For example, the reagent layer 107 may be thinly formed on the bottom surface of the channel 102.

### Second Embodiment

The second embodiment of the present invention will be described below.

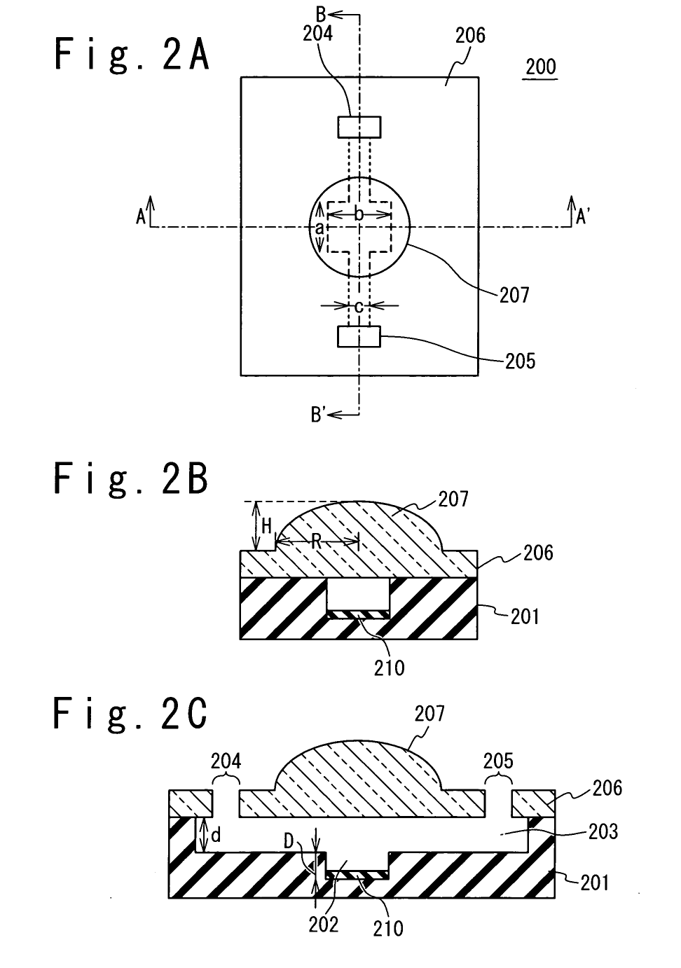

FIG. 2A is a top view of an analysis chip 200 according to this embodiment. Also, FIG. 2B and FIG. 2C show an A-A′ sectional view and B-B′ sectional view in FIG. 2A, respectively.

In the analysis chip 200, a transparent coating 206 is formed on a substrate 201 in which a reacting bath 202 and a channel 203 are placed, and a micro lens 207 is further placed on the coating 206. Also, a reagent layer 210 is placed on the bottom surface of the reacting bath 202. Then, the micro lens 207, a sample introduction port 204 to introduce an analysis sample through the channel 203 into the reacting bath 202, and an exhaust port 205 to enable the air in the channel 203 and the like to be exhausted when the analysis sample is introduced are placed in the coating 206.

A using method of the analysis chip 200 will be described below. The sample of the analysis target is injected from the sample introduction port 204 and introduced through the channel 203 into the reacting bath 202 by capillary effect, pump press-fitting, electric permeation flow or the like. If a particular component is included in the sample, since the reacting bath 202 includes the reagent layer 210 containing the reagent whose mutual action with the particular component results in color generation or light emission, the existence of the particular component is detected. Thus, the existence of the particular component can be known by recognizing the color generation or light emission. Also, a concentration of the particular component contained in the sample can be known which will be described later.

Since the micro lens 207 is placed in this analysis chip 200, the color generation, light emission, color change, color loss or extinction occurring in the reacting bath 202 can be visually recognized in detail. Thus, even if the reacting bath 202 is small, the color generation or light emission can be visually recognized. Hence, since the volume of the reacting bath 202 can be small, in the analysis based on the analysis chip 200, the amount of the sample to be provided to the analysis can be made smaller.

The analysis chip in this embodiment can be applied to the detection and quantification of the various substances. The applications to: the blood biochemistry inspection of glucose, alanine aminotransferase, albumin, alkali phosphatase, amylase, calcium ion, total cholesterol, lipoperoxide, creatinine, potassium ion, bilirubin, total protein and the like; the immunity serologic inspection of Hbs antigen and antibody, HCV antibody, HIV antibody and the like; and the tumor marker of CEA, CA19-9, PSA, CA-125 and the like are exemplified.

For example, the lipoperoxide can be detected by making the reagent layer 210 contain cytochrome C and luminol. The mechanism in this case is as follows. The lipoperoxide included in the sample reacts with the cyhtochrome C, and active oxygen is generated. Due to this active oxgen, light is emitted when the luminol is oxidized. Thus, due to the light emission at this time, the lipoperoxide can be detected. Also, in the case of the glucose, as shown in the explanation of the first embodiment, the glucose can be detected by using the generation reaction of chinone-based dye. Moreover, in the case of the HCV antibody, CEA, PSA, hCG, antibody to abnormal prion, antibody to β amyloid or p97 protein, and the like, they can be detected in accordance with the fixed layer immunity quantifying method or the ELISA method or the method using the latex bead, which is explained in the first embodiment.

When the colorization reaction is used to carry out the quantification, for example, by placing the hue patterns A, B and C having the same hues as the hues exhibited if particular substances of predetermined amounts a, b and c exist in the sample, in the vicinity of the reacting bath 202, and then comparing the hue of the colorization reaction in the reacting bath 202 with the hue patterns A, B and C, the quantification of the particular substance can be executed simply and quickly. The hue pattern does not need to be the actual reaction solution. For example, the liquid having the same hue like the transparent coating, the material solidified at the transparent state like enamel paint, and the colored acryl plate and the like can be used.

As mentioned above, according to the analysis chip 200 in this embodiment, the quantification analysis of the particular component can be quickly executed by using only this analysis chip without any usage of other analyzing equipments.

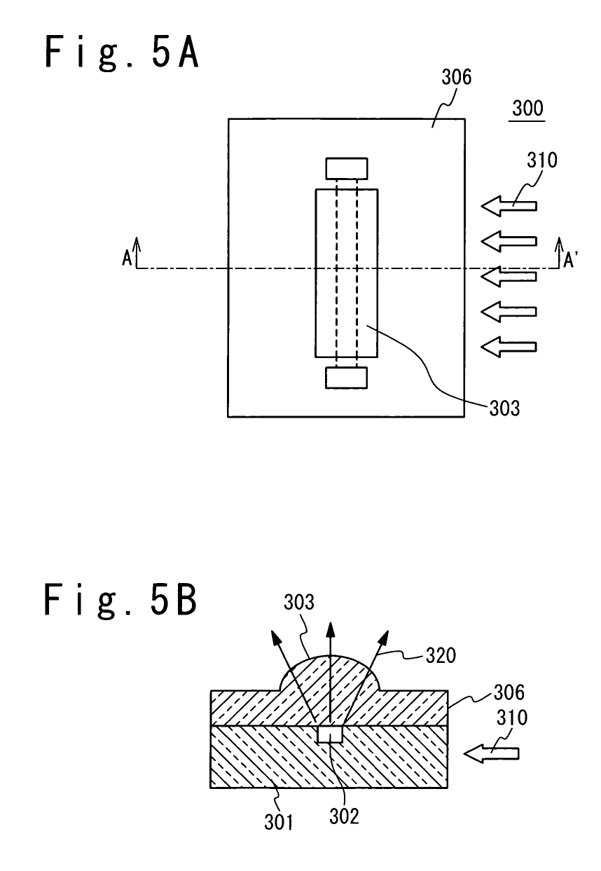

As the material of the substrate 201 (FIG. 2) of the analysis chip 200 in this embodiment, for example, glass, silicon substrate or plastic material, such as PMMA, PET, PC and the like, are exemplified. By the way, when the color generation reaction is used to detect the particular component, from the viewpoint of the effective usage of an assistant illumination (FIGS. 5 to 9) which will be described later, the transparent material, such as glass, PMMA, PET, PC and the like, is preferably selected.

The size of the substrate 201 is not especially limited. For example, both of the longitudinal and lateral lengths may be 2 to 3 cm. Even the thickness is not especially limited. For example, it may be 0.2 to 0.7 cm. Also, the reacting bath 202 and the channel 203 can be formed by the known method suitable for the material of the substrate 201, such as the etching or molding to pour the plastic resin into the die. The hydrophilic process may be performed on the inner walls of the reacting bath 202 and channel 203, for the easy pass of the sample. The hydrophilic process can be carried out, for example, by using the LIPIDURE (registered trademark made by NOFCORPORATION)). In this case, in such a way that the LIPIDURE (registered trademark) becomes, for example, 0.5 wt %, it is dissolved in the buffer solution such as the TBE buffer and the like. By filling this solution in the reacting bath 202 and channel 203 and leaving for several minutes, and then removing the liquid with the air gun or the like and drying it, the hydrophilic process can be performed on the inner walls of the reacting bath 202 and channel 203. The size of the reacting bath 202 is not especially limited. For example, both of a and b may be 100 to 300 μm, and D may be 100 to 400 μm. Also, the size of the channel 203 is not especially limited. For example, c may be 50 to 200 μm, and d may be 50 to 100 μm. As the materials of the coating 206 and micro lens 207, the transparent material is selected so as to observe the inside of the reacting bath 202, such as the glass or the plastic material such as PET. As the size of the micro lens 207, for example, H may be 0.25 mm to 11.0 mm, and R may be 0.25 to 1.0 mm.

Also, the reagent layer 210 can be produced, for example, as follows. CMC (carboxy-methyl cellulose) as the binder is dissolved into a moderate amount of water, and a reagent of a predetermined amount is mixed into this solution. The thus-obtained mixture is poured into the reacting bath 202 and dried under dry argon or dry nitride atmosphere. Then, the reagent layer 210 can be formed.

Also, the reagent layer 210 can be also formed as follows. As the binder, the sol containing the hydrophilic polymer such as agarose, poly-acryl-amide, methyl cellulose and the like is prepared. This sol and a reagent of a predetermined amount are mixed. The thus-obtained sol is poured into the reacting bath 202 and naturally cured, thereby making into the reagent layer 210. Here, after the natural curing, it may be dried in dry air and the like. Thus, the life time of the reagent layer 210 can be made longer.

### Third Embodiment

The third embodiment of the present invention will be described below. In the environment where sufficient light amount can not be obtained such as a dark room, when the analysis chip described in the first or second embodiment is used to carry out the analysis, the channel or reacting bath is very small, which may result in the case that the color generation cannot be sufficiently recognized only by the enlargement of the micro lens. So, in this embodiment, the mechanism is explained in which the visibility can be improved even under the environment where the sufficient light amount cannot be reserved.

The principle of this embodiment will be described below with reference to FIG. 5. Although an analysis chip 300 shown in FIG. 5 has the configuration similar to the analysis chip shown in the first embodiment, the transparent material is used as the material of a substrate 301. Then, as shown in FIG. 5, a light 310 is emitted from the side of the substrate 301. Apart of the emitted light 310 collides with a dye existing in a channel 302. Irregular reflection is induced, and a scattered light 320 is generated. The scattered light 320 is measured through a micro lens 303. This scattered light 320 improves the visibility of the channel 302.

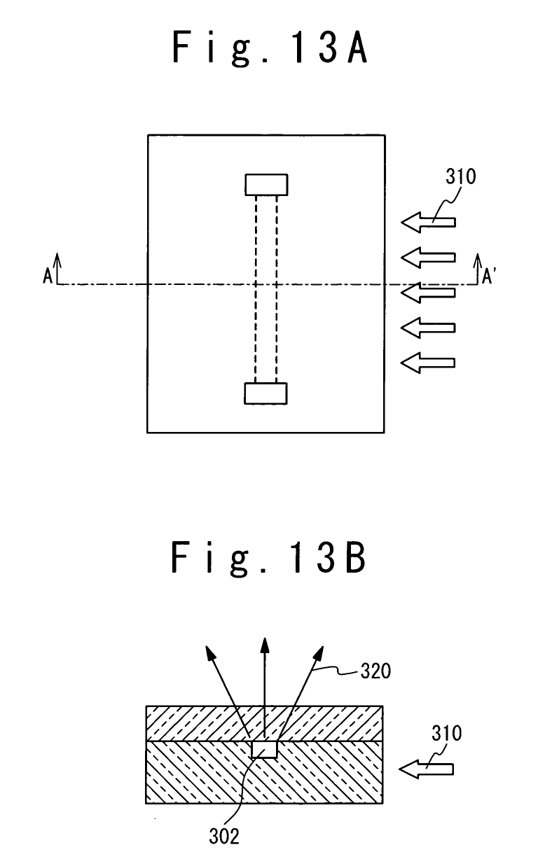

By the way, if the visual recognition is possible without any enlargement of the appearance in the channel 302, the configuration as shown in FIG. 13 that does not have the micro lens can be also employed. Even in the analysis chip in this drawing, similarly to the case of the above analysis chip 300, the scattered light 320 caused by the light 310 contributes to the improvement of the visibility of the channel 302.

Here, in FIG. 5A, let us consider the case that the light is emitted from the vertical direction of the sheet paper surface. In this case, the emitted light is reflected not only by the dye in the channel but also by the micro lens 303 and a coating 306. Thus, the contrast of an image in the channel is decreased. On the contrary, in the case of the analysis chip 300 in this embodiment, the reflection lights from the micro lens 303 and coating 306 are not observed, and only the scattered light 320 is observed, which makes the contrast of the image in the channel 302 higher. Hence, in the analysis chip 300, the excellent visibility can be obtained.

Here, in the case that the hue pattern described in the second embodiment is used to carry out the quantification, a micro concave portion is formed in a region along the channel 302 on the substrate 301, and the hue pattern can be placed in the concave portion. Thus, both of the hue of the colorization reaction in the channel 302 and the hue pattern can be compared under the illumination of the scattered light 320. Hence, the concentration can be accurately measured.

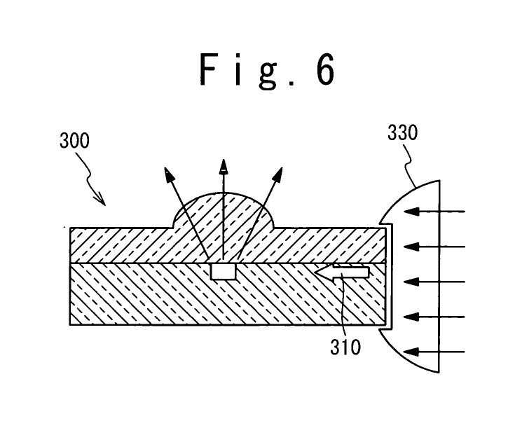

The supplying method of the light 310 is not especially limited. For example, the light 310 can be supplied by placing a light collecting lens 330 shown in FIG. 6 on the side of the analysis chip 300.

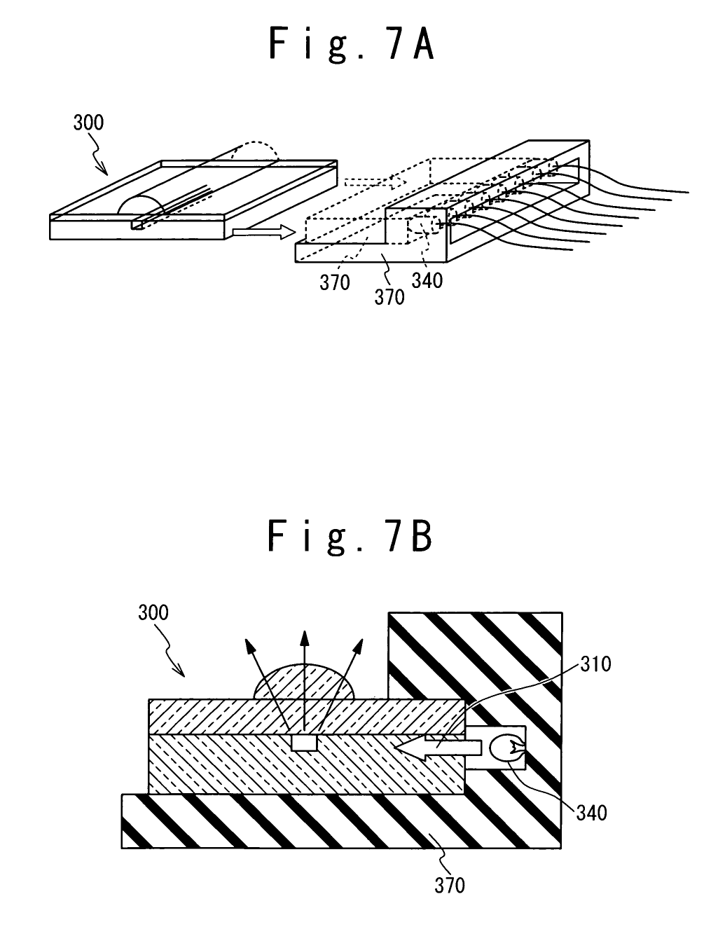

Also, as shown in FIG. 7A, by setting the analysis chip 300 on a side illuminating unit 370 having a light source 340 and a socket 350, the light can be supplied from the light source 340. FIG. 7B is a sectional view of a state that the analysis chip 300 is placed on the side illuminating unit 370, and shows the manner that the light 310 is supplied from the light source 340 to the analysis chip 300. By setting the light amount emitted from the light source 340 at the optimal condition in advance, the analysis and the measurement can always be stably carried out. Here, the various light sources such as a usual electric lamp (a fluorescent lamp, a bulb or the like), LED can be used as the light source 340. Also in the case that the fluorescence is used to detect the particular substance, a black light that can emit a near ultraviolet ray or the like can be used as the light source 340. Moreover in this case, as the substrate 301, UV transparence plastic, UV quartz or the like are preferably used in order to transmit the near ultraviolet ray. Here, the light collecting lens 330 and the side illuminating unit 370 correspond to the above second illuminating member.

### Fourth Embodiment

This embodiment shows the mechanism for improving the visibility of the channel by using a method different from the third embodiment.

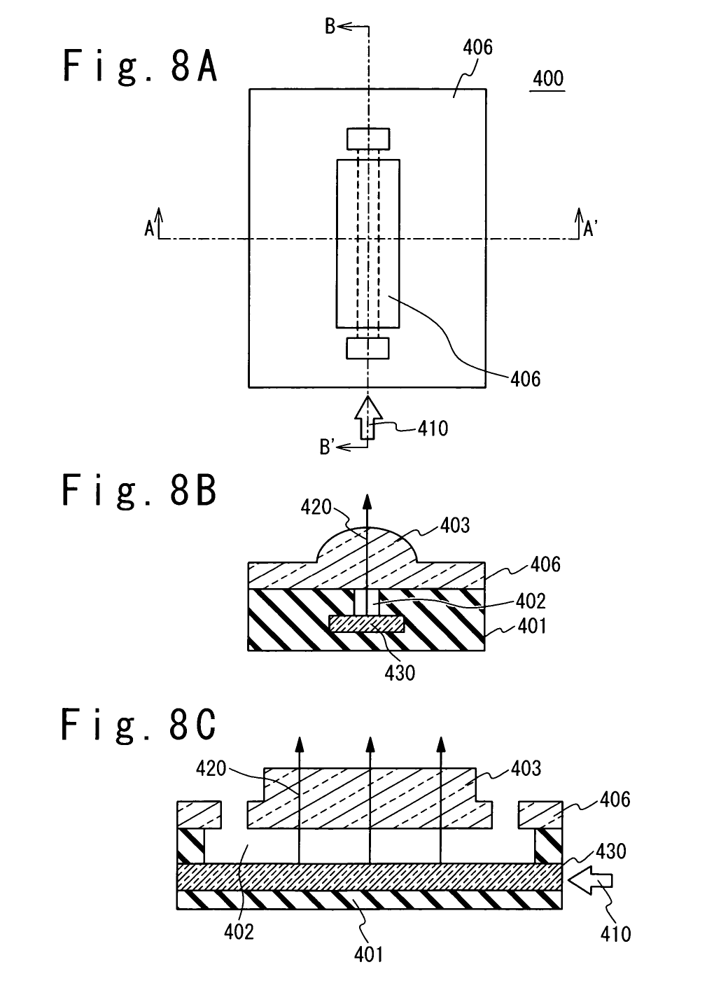

FIG. 8 is a view indicating an analysis chip 400 according to this embodiment. FIG. 8A is a top view of the analysis chip 400. Also, FIG. 8B and FIG. 8C show an A-A′ sectional view and B-B′ sectional view in FIG. 8A, respectively.

An optical wave guide 430 corresponding to the above first illuminating member is formed in the analysis chip 400 so as to be enclosed by a substrate 401. The bottom surface of a channel 402 is constituted by the surface of the optical wave guide 430. Also, similarly to the analysis chip shown in the first embodiment, the substrate 401 has a transparent coating 406 and further includes a micro lens 403 thereon.

As shown in FIG. 8, when a light 410 enters from a tip of the optical wave guide 430 to the analysis chip 400, the light goes through the optical wave guide 430. Apart of the light exits from the optical wave guide 430 as a refractive light 420 and passes through the channel 402, the coating 406 and the micro lens 403. Thus, the clear image of the channel 402 is obtained. Also, since the refractive light 420 is the indirect light to illuminate only the vicinity of the channel 402, the image of a high contrast can be obtained as compared with the case that the light is emitted as back light from the rear of the analysis chip 400.

The absolute refractive index of the material of the optical wave guide 430 is preferably set to be higher than the absolute refractive index of the material of the substrate 401. Thus, the light 410 can be efficiently guided, thereby obtaining a larger quantity of refractive light 420. In order to achieve the effect, for example, the material of the substrate 401 can be PMMA (an absolute refractive index 1.49), and the material of the optical wave guide 430 can be PET (an absolute refractive index 1.79) or PC (an absolute refractive index 1.73).

As a method of forming the optical wave guide 430 in the substrate 401, a method of making a hollow portion by cutting the substrate 401, and pouring a melted resin which is a material of the optical wave guide 430 into the hollow portion, and then cooling and consequently forming the optical wave guide 430 is exemplified. After the optical wave guide 430 is formed in the substrate 401 as mentioned above, the channel 402 is formed in the substrate 401. Here, the coating 406 and the micro lens 403 can be configured similarly to the first embodiment.

A light source for supplying the light 410 is not especially limited. Similarly to the third embodiment, for example, the regular electric lamp (the fluorescent lamp, the bulb or the like), the LED, the black light or the like can be used.

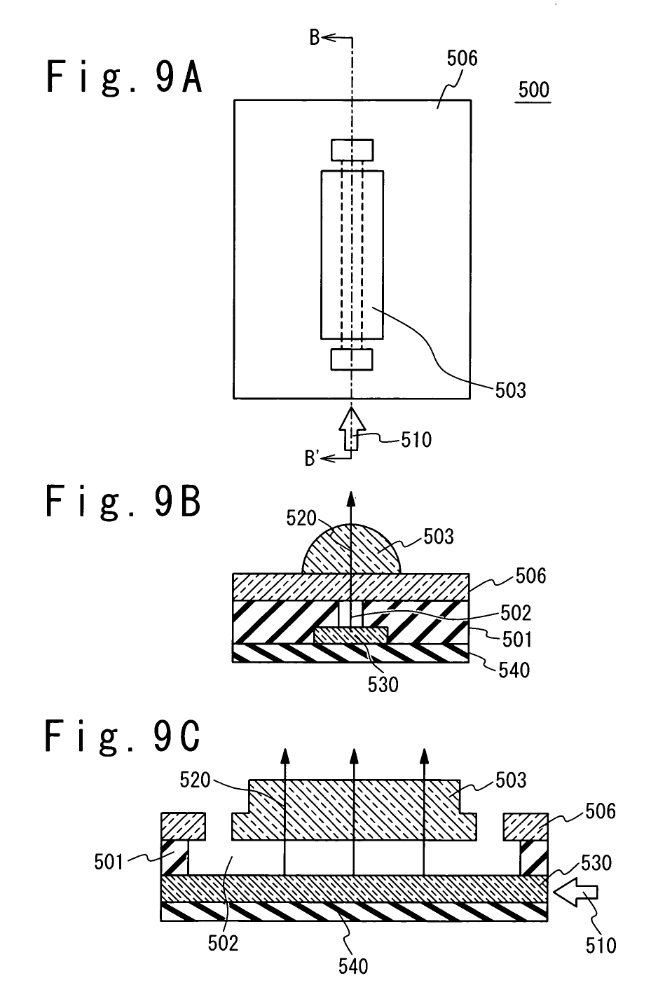

As a variation of the embodiment having the optical wave guide, an analysis chip 500 shown in FIG. 9 is also exemplified. FIG. 9A is a top view of the analysis chip 500. FIG. 9B and FIG. 9C show an A-A′ sectional view and B-B′ sectional view in FIG. 9A, respectively. The analysis chip 500 is different from the analysis chip 400, in that there is a protective layer 540 on the bottom surface. The other configuration basically employs the configuration similar to the analysis chip 400 shown in FIG. 8. Then, by emitting a light 510 to an optical wave guide 530 to generate a refractive light 520, an image in a channel 502 can be observed through a micro lens 503 at an excellent visibility.

In the case of the analysis chip 500, the optical wave guide 530 can be formed as follows. A groove for implementing the optical wave guide 530 is formed on the bottom surface of a substrate 501 having the channel 502 by cutting. Next, melted resin as material of the channel 502 is poured into the groove and then cooled and solidified and made into the optical waveguide 530. After that, the substrate 501 and the protective layer 540 are bonded by the fusion, the press-fitting of supersonic wave, or the adhesion of adhesive, or the like. The above groove can be attained by applying the method described in the first embodiment instead of the forming method based on the cutting. That is, the die from which the substrate having the above groove and channel 502 can be formed is produced in advance by using the precise processing machine, and this die and the high precision injection molding machine are used to carry out the plastic injection molding. Thus, the substrate 501 having the channel 502 and the above groove can be obtained. Also, as the material of the optical wave guide 530, ultraviolet ray curing resin (for example, J-91 (made by Summers Optical Corporation) can be also used. In this case, the ultraviolet ray curing resin is coated and filled in the above groove at monomer state, and it is polymerized and cured by being emitted the ultraviolet ray. Hence, the optical wave guide 530 can be easily placed.

As the material of the protective layer 540, the plastic material such as PMMA, PET and PC, and glass or the like are exemplified. Here, the coating 506 and the micro lens 503 can be configured similarly to the first embodiment.

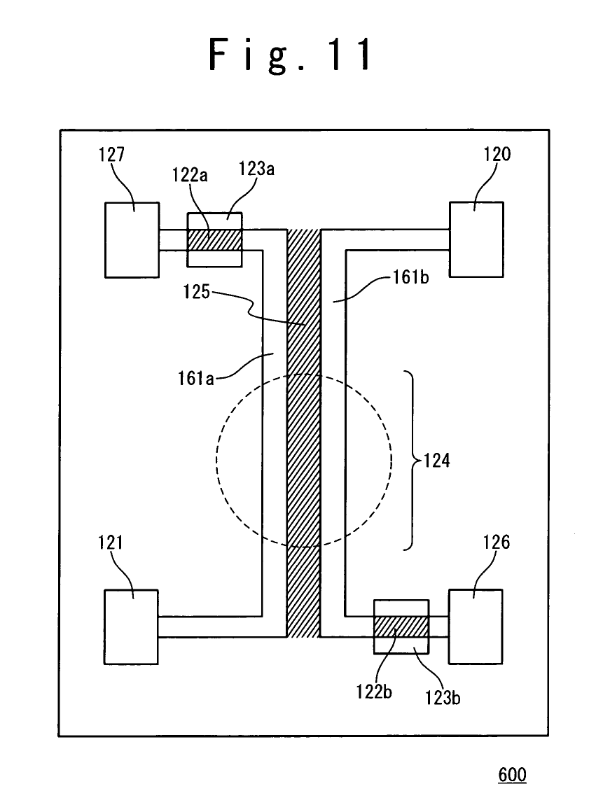

As mentioned above, the analysis chips according to the embodiments of the present invention have been explained. These analysis chips can be used in combination with a different micro chip, in addition to the single usage. For example, the seamless connection between the micro chip having a separating function and the analysis chip of the present invention enables the separation, purification, detection and measurement of the sample to be rapidly executed by using only the chip. Also, for example, by adding the separating function onto the analysis chip described in any of the above embodiments, the separation, purification, detection and measurement of the sample can be rapidly executed by using only one chip. An example of the analysis chip is shown in FIG. 11. An analysis chip 600 has channels 161a, 161b, and a barrier 125 exists between those two channels. A separation region 124 is formed at a predetermined position of the barrier 125. Reagent layers 122a, 122b to detect the particular substance separated by this separation region 124 are formed at predetermined positions of the channels 161a, 161b, respectively. Further, micro lenses 123a, 123b are placed so as to be able to enlarge and recognize the reagent layers 122a, 122b, respectively.

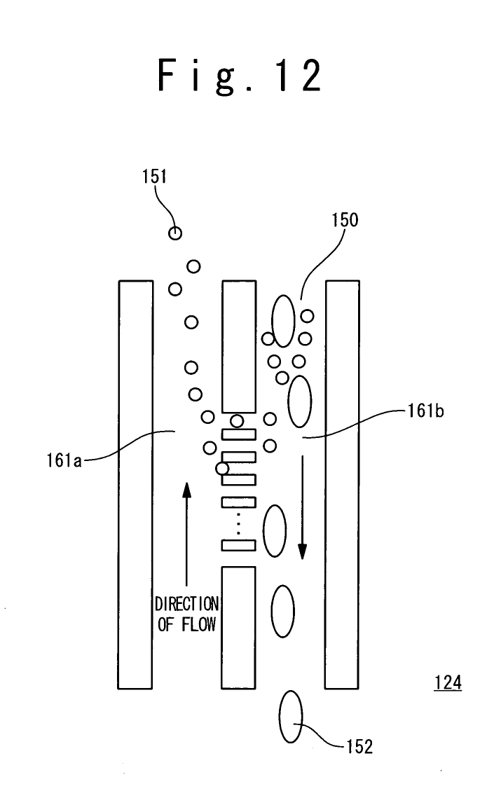

The using method of an analysis chip 600 will be described below with reference to FIG. 11 and FIG. 12. FIG. 12 is the view showing by enlarging the vicinity of the separation region 124 in FIG. 11. The sample is injected from a sample introducing port 120 and flows toward a reservoir 126 through the channel 161b by the capillary effect, the press-fitting of air pressure, the electric permeation flow or the like. On the other hand, a buffer solution is injected from a buffer solution introducing port 121 and flows toward a reservoir 127 through the channel 161a by the capillary effect, the press-fitting of air pressure, the electric permeation flow or the like. Thus, as shown in FIG. 12, the directions of the flows of the channels 161a and 161b are opposite to each other.

Here, the mechanism of the separation in the separation region 124 is explained with reference to FIG. 12. When a sample 150 having a small particle 151 and a large particle 152 passes through the channel 161b downwardly in FIG. 12, the small particle 151 included in the sample 150 passes through a separation channel placed on a barrier shown at the center of FIG. 12 and moves to the adjacent channel 161a. The small particle 151 moved to the channel 161a together with the buffer solution flowing upwardly in FIG. 15 is fed in the same direction. On the other hand, the large particle 152 that cannot pass through the above separation channel remains in the channel 161b and flows downwardly in FIG. 15. In this way, the small particle 151 and the large particle 152 are separated by the separation region 124. The separated small particle 151 and large particle 152 are detected by the reagent layers 122a, 122b, respectively, and their changes can be enlarged by the micro lenses 123a, 123b and recognized.

Here, as the material of the coating of the analysis chip 600, the hydrophobic material is preferably employed. This causes the hydrophilic degrees of the inner walls of the channels 161a, 161b to be dropped, which is convenient on the operation with regard to the following points. In order to attain the separation by using the analysis chip 600, the buffer solution and the sample need to be prevented from any overflow to the outside of a predetermined channel Thus, it is ideal to simultaneously feed the buffer solution and the sample to the separation region 124. However, this is usually difficult. With regard to this point, if the hydrophilic degree of the inner wall of the channel is moderately dropped, the advancement in the channel of the buffer solution or sample becomes slow. Thus, for example, even if the buffer solution is introduced into the channel 161a in advance, the buffer solution does not overflow into the channel 161b. By introducing the sample into 161b at this state, while the state that the buffer solution and the sample flow in the channels 161a, 161b, respectively, is kept, the separation is attained in the separation channel placed in the barrier at the center of FIG. 12.

The analysis chip 600 of FIG. 11 can be applied to, for example, the analysis of flood. In this case, a blood cell component, which is relatively large, corresponds to the large particle 152, and a component except the blood cell corresponds to the small particle 151. By containing a reagent that can detect a particular substance in the blood in the reagent layer 122a, the particular substance can be directly analyzed from the blood without executing a pre-process such as a centrifugal separating operation or the like. Here, in this case, the blood as the sample is introduced from the sample introducing port 120 (FIG. 11).

By the way, FIG. 11 shows the analysis chip including the two channels. However, the inclusion of three channels or more enables the separation into the molecule of the size of three kinds or more. Also, with regard to the reagent layer, the reagent layer may be formed in each of the channels, as described in the analysis chip of FIG. 11, or the formation in only one of the channels may be employed.

As mentioned above, the analysis chip of the present invention, since having the detector for detecting the sample and the micro lens formed so as to cover the detector, does not further require the special external equipment for the detection and analysis. Moreover, after the application of the specimen, the analysis result can be obtained at that position quickly and visually.

### Fifth Embodiment

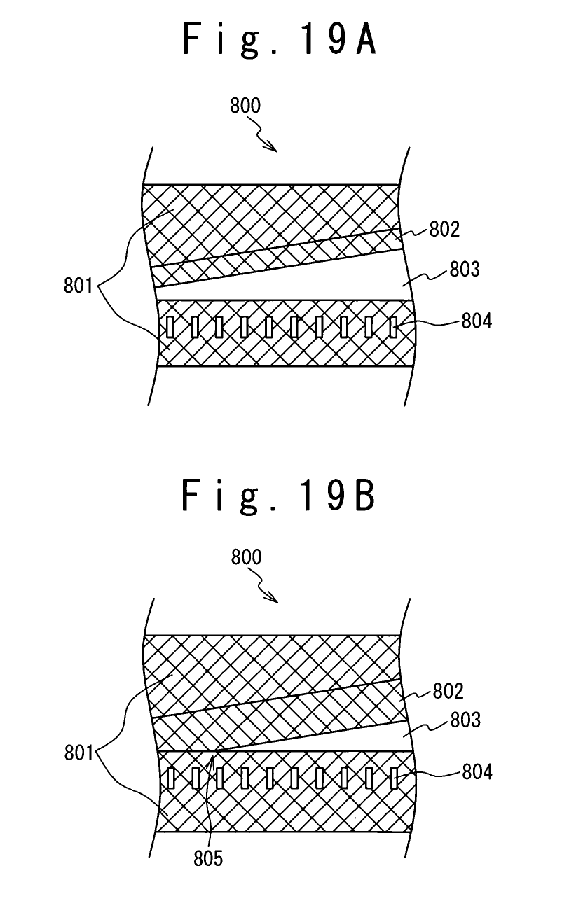

FIG. 19A is a top view for explaining a configuration of an analysis chip in this embodiment. An analysis chip 800 includes a substrate 801. A channel 803 is formed on the substrate 801. The channel 803 can be formed by the same method as the method of forming the channel 102 in the substrate 101 in the first embodiment. The channel 803 is formed such that the width is continuously monotonously increased or monotonously decreased.

A layer of a hydro-gel 802 is formed on at least one side of the channel 803. The hydro-gel 802 is the chemical substance sensing hydro-gel (CSG). When it is brought into contact with the substance of a particular kind (exemplification: glucose), the volume is increased.

The increase in the volume becomes greater as the amount of the substance is greater. A scale 804 is placed on the side of the channel 803.

A micro lens for magnifying is preferably placed on the channel 803. The illuminating tool for emitting the light to the channel 803 is further preferably placed.

The analysis chip 800 having such configuration is used as follows. The solution of a certain amount is introduced into the channel from an introduction port (not shown) placed in one of the channels 803. Dye to improve the visibility is preferably mixed in the solution. The solution flows from one of the channels 803 to the other.

When the solution contains a particular component having a sensibility, the hydro-gel 802 is swelled. FIG. 19B shows the analysis chip 800 when the hydro-gel 802 is swelled. The swelled hydro-gel 802 clogs the portion where the width of the channel 803 is narrow, and stops the invasion of the solution. The position where the invasion of the solution stops is indicated as a stop position 805. As the particular component contained in the solution is greater, the stop position 805 becomes on the side where the width of the channel 803 is wider (the right side of FIG. 19B). As the particular component contained in the solution is smaller, the stop position 805 becomes on the side where the width of the channel 803 is narrower (the left side of FIG. 19B). The stop position 805 can be quantitatively measured by naked eyes. Thus, the amount of the particular component contained in the solution can be measured by the naked eyes.

The variation of this embodiment will be described below. The configuration of the analysis chip 800 in this variation is shown in FIG. 19B. Differently from the previous example, the analysis chip 800 before the solution is introduced from the introduction port is shown in FIG. 19B. The layer of the hydro-gel 802 is formed on at least one side of the channel 803. The hydro-gel 802 is the chemical substance sensing hydro-gel (CSG). When it is brought into contact with the substance of the particular kind (exemplification: glucose), the volume is decreased. The decrease in the volume becomes greater as the amount of the substance is greater.

The analysis chip 800 having such a configuration is used as follows. The solution of a certain amount is introduced into the channel from the introduction port (not shown) placed in one end of the channels 803. The solution flows from one end of the channels 803 to the other.

When the solution includes a particular component to which the hydro-gel 802 has sensibility, the hydro-gel 802 shrinks. As the amount of the particular component is greater, the volume change by the shrinkage of the hydro-gel 802 is greater. As the volume change by the shrinkage is greater, the portion where the hydro-gel 802 blocks the channel 803 is reduced, and the stop position 805 is moved to the side where the width of the channel 803 is narrow (the left side of FIG. 19B). Thus, the amount of the particular component contained in the solution can be measured by reading the stop position 805 by the scale 804.

The documents describing about the hydro-gel that can be used in the analysis chip in this embodiment will be described below.

An example of a pH sensible hydro-gel whose volume is changed depending on the pH of a component targeted for the detection is indicated in the following documents.
(1) Iio, K., Minoura, N., Nagaura, M. (1995) Swelling characteristics of a blend hydrogel made of poly (allylbiguanido-co-allylamine) and Poly (vinyl alchol), Polymer 36: 2579-2583
(2) Beebe, D. J. et. al. (2000) Functional hydrogel structures for autonomous flow control inside microfluidic channels, Nature 588-590

An example of a glucose sensible polymer whose volume is changed depending on an amount of glucose of a component targeted for the detection is indicated in the following documents.
(1) Cartier, S., Horbert, T. A., Ratner, B. D. (1995) Glucose-sensitive membrane porous filters for control of hydraulic permiability, and insulin delivery from a pressurized reservoir, Journal of Membrane Science 106: 17-24
(2) Podual, K., F. J., and Peppas, N. A. (2000) Preparation and dynamic response of catalytic copolymer hydrogels containing glucose oxidase. Polymer 41: 3975-3983.

Enzyme, which decomposes a particular substance and generates acid and hydrogen peroxide or the like, is mixed with such polymer. On the basis of a pH change and a hydrogen peroxide concentration, which are caused by the result of the action of the enzyme, the volume change of the polymer or the change in a hole size occurs. By changing the kinds of the enzyme and the chemicals to be mixed, the polymer gel reacting to more kinds of substances can be produced.

### Sixth Embodiment

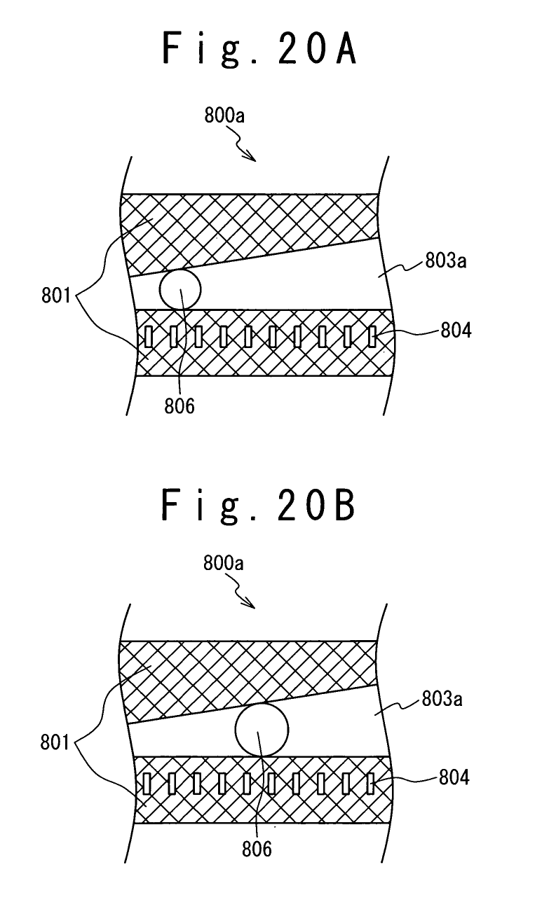

FIG. 20A is a top view explaining a configuration of an analysis chip in this embodiment. An analysis chip 800a includes a substrate 801. A channel 803a is formed on the substrate 801. The channel 803a can be formed by the same method as the method of forming the channel 102 on the substrate 101 in the first embodiment. The channel 803a is formed such that the width is continuously monotonously increased or monotonously decreased. The scale 804 is placed on the side of the channel 803a.

A bead 806 is set in the channel 803. Gaudy color for making the visibility high is coated on the surface of the bead 806. In the bead 806, the surface is made of hydro-gel. The hydro-gel is the chemical substance sensibility hydro-gel (CSG). When it is brought into contact with the substance of the particular kind (exemplification: glucose), the volume is increased. The increase amount of the volume becomes greater as the amount of the substance is greater.

A micro lens for magnifying is preferably placed on the channel 803a. The illuminating tool for emitting the light to the channel 803a is further preferably placed.

The analysis chip 800a having such configuration is used as follows. The solution of a certain amount is introduced into the channel 803a from an introduction port (not shown) placed at the end on the side where the width of the channel 803a is wider. The dye to improve the visibility is preferably mixed in the solution. The solution flows from one end of the channels 803 to the other. The bead 806 is carried away by the solution and stopped at the position where the width of the channel 803a is equal to a diameter of the bead 806.

When the solution includes a particular component to which the hydro-gel forming the surface of the bead 806 has sensibility, the hydro-gel is swelled, and the size of the bead 806 becomes large. The analysis chip 800a when the size of the bead 806 becomes large is shown in FIG. 20B. As the size of the bead 806 is larger, the bead 806 is stopped at the position where the width of the channel 803 is wider. As the amount of the particular component is greater, the bead 806 is stopped at the position where the width of the channel 803 is wider. Thus, by reading the stop position of the bead 806 from the scale 804 or reading the stop position of the colored solution from the scale 804, the amount of the particular component in the solution can be quantitatively measured.

### Seventh Embodiment

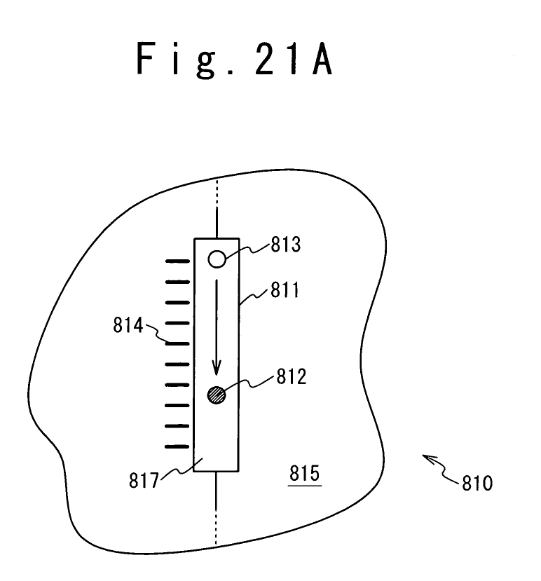

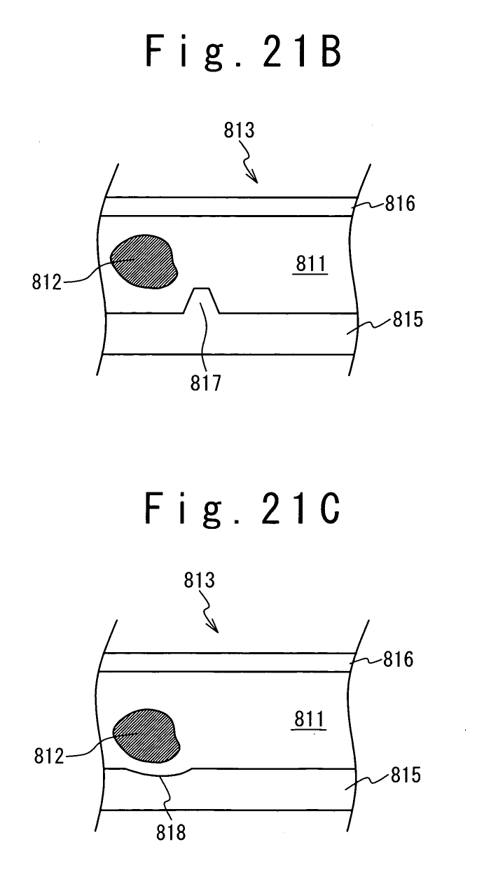

A top view of a detection chip 800 in this embodiment is shown in FIG. 21A. An analysis chip 810 includes a substrate 815. A channel 811 is formed in the substrate 815. A scale 814 is placed on the side of the channel 811. A bead 812 is set inside the channel 811. A size of the bead 812 is smaller than the minimum width of the channel 811.

The bead 812 has the visible size. If the bead 812 is fluorescently colored or formed by using a fluorescent material, the size of the bead can be reduced a little while the visibility is kept. In the case of using the bead 812 of the fluorescent color, in order to observe the manner in the channel 811, the width of the channel 811 may be approximately loam to 100 μm, and the bead 812 may have the size slightly smaller than it.

The bead 812 has the core of a heavy metal exemplified as iron and lead. The outer side of the bead 812 is coated with resin that is excellent in visibility and gaudy in color. The shape of the bead 812 is the shape of a ball, rotary ellipsoid, bar, spiral, propeller or the like.

A polymer solution 817 is filled in the channel 811. The viscosity of the polymer solution 817 is changed in accordance with a concentration of a particular substance. As the polymer solution 817, the dilute solution of the chemical substance sensible hydro-gel (CSG) used in the analysis chip 800 in the fifth embodiment or the solution in which a polymerization degree is dropped can be used.

A micro lens for magnifying is preferably placed on the channel 811. The illuminating tool for emitting the light to the channel 811 is further preferably placed.

A tentative fixer 813 is placed near one end of the channel 811. A sectional view indicating the configuration of the vicinity of the tentative fixer 813 when it is viewed from the side is shown in FIG. 21B. The channel 811 is formed on the substrate 815, and the channel 811 is sealed with a cover 816. The cover 816 is made of transparent material. The bead 812 is set in the channel 811. A bump 817 is formed in the tentative fixer 813. The bump 817 is preferred to be high, to a degree that the bead 812 cannot easily exceed in the state in which the analysis chip 810 is flatly placed and preferred to be low, to a degree that the bead 812 can easily exceed when the analysis chip 810 is greatly inclined.

A sectional view when it is viewed from the side indicating another configuration near the tentative fixer 813 is shown in FIG. 21C. In this configuration, a concavity 818 is formed in the tentative fixer 813. The concavity 818 is preferred to be deep, to a degree that the bead 812 cannot easily move in the state in which the analysis chip 810 is horizontally placed and preferred to be shallow, to a degree that the bead 812 can easily exceed when the analysis chip 810 is greatly inclined.

The analysis chip 810 having such configuration is used as follows. The analysis chip 810 is placed on a horizontal plane. The bead 812 is tentatively fixed to the tentative fixer 813. Solution is introduced from an introduction port (not shown) placed at one end of the channel 811. The solution flows through the channel 811. In the polymer solution 817, in accordance with a concentration of the particular substance contained in the solution, the viscosity is changed.

A user of the analysis chip 810 changes the pose of the analysis chip 810 so that an extension direction of the channel 811 is a vertical direction. The bead 812 is released from the tentative fixer 813 and begins to fall in the vertical direction. A fall speed of the bead 812 is dependent on the viscosity of the polymer solution 817. By measuring the falling length of the bead 812 in a certain time, the viscosity of the polymer solution 817 is quantitatively measured. Or by measuring the time until the bead 812 arrives at a predetermined position, the viscosity of the polymer solution 817 is quantitatively measured. From the measured viscosity of the polymer solution 817, the concentration of the particular substance contained in the solution is known.

An analysis chip in a variation of this embodiment will be described below. The analysis chip in the variation is such that in the analysis chip 810 shown in FIG. 21A, the bead 812 has a core made of a ferromagnetic material exemplified as iron or a ferrite magnet. The other configurations are equal to the above explanation.

The analysis chip is used together with a magnet having a predetermined magnetic force. When the analysis chip is used, a bead 811 is tentatively fixed to the tentative fixer 813. The solution is introduced from the introduction port (not shown) placed at one end of the channel 811. The solution flows through the channel. The viscosity of the polymer solution 817 is changed depending on the concentration of the particular substance contained in the solution.

A user of the analysis chip 810 places the magnet having the predetermined magnetic force, at a position on an extension line of the end opposite to the tentative fixer 813 of the channel 811. The bead 812 is released from the tentative fixer 813 and begins to move in a direction where the magnet is placed. The movement speed of the bead 812 is depending on the viscosity of the polymer solution 817. By measuring the moving distance of the bead 812 in the certain time, the viscosity of the polymer solution 817 is quantitatively measured. Or by measuring the time until the bead 812 arrives at the predetermined position, the viscosity of the polymer solution 817 is quantitatively measured. From the measured viscosity of the polymer solution 817, the concentration of the particular substance contained in the solution is known.

An analysis chip in another variation of this embodiment includes a reacting bath and a quantification bath. The reacting bath is filled with the polymer solution whose viscosity is changed through the reaction with the particular substance, and an introduction port to introduce an inspection substance is placed therein. A feeding path having a valve is placed between the reacting bath and the quantification bath. The solution accumulated in the reacting bath can be fed into the quantification bath through the feeding path. The quantification bath includes an outlet of the feeding path opened in the channel 811, in addition to the configuration of the analysis chip 810 shown in FIG. 21A.

The analysis chip is used as follows. The inspection substance is introduced from the introduction port. The viscosity of the polymer solution is changed depending on the concentration of the particular component contained in the inspection substance.

The polymer solution is fed from the reacting bath through the feeding path to the quantification path. The quantification bath is filled with the polymer solution. The viscosity of the polymer solution is measured by using the above method. The concentration of the particular component contained in the inspection substance is quantitatively measured from the measured viscosity. Thus, the concentration of the particular component contained in the inspection substance is measured quantitatively.

### Eighth Embodiment

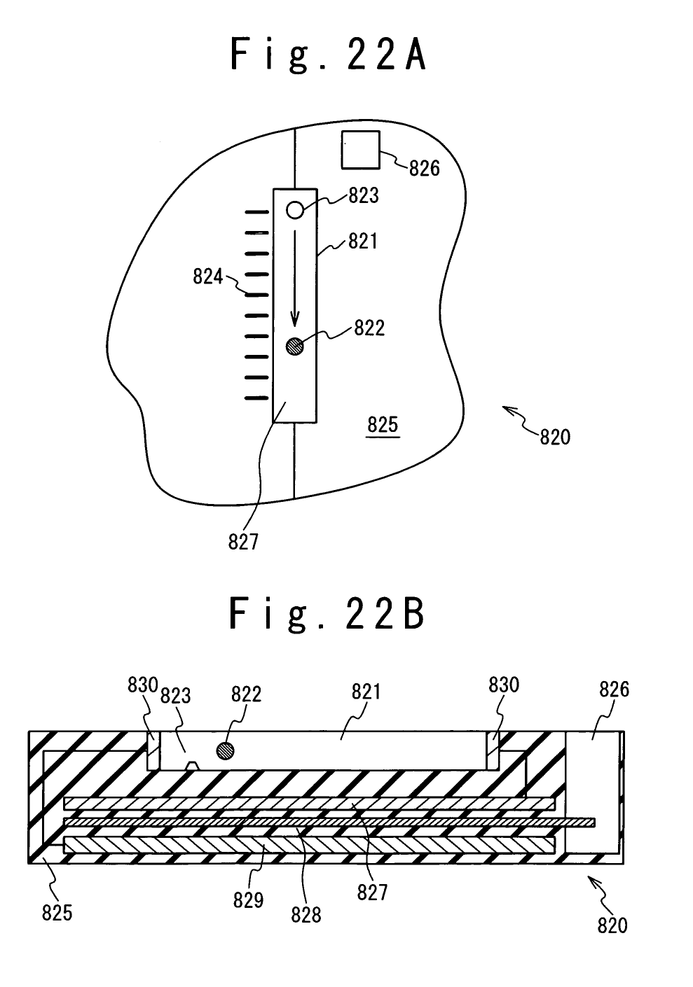

A top view of an analysis chip 820 in this embodiment is shown in FIG. 22A. The analysis chip 820 includes a substrate 825. A channel 821 is formed on the substrate 825. The channel 821 is filled with a polymer solution 827. The polymer solution 827 is same substance with the polymer solution 817 in the seventh embodiment. A scale 824 is placed on the side of the channel 821. An electrolyte introduction port 826 is further placed in the substrate 825.

A bead 822 is set in the channel 821. A size of the bead 822 is smaller than the minimum width of the channel 821. The bead 822 is made of light substance such as resin or the like. The surface is made of material which is electrified depending on the pH of a buffer.

A tentative fixer 823 is placed near one end of the channel 821. The configuration of the tentative fixer 823 is equal to the tentative fixer 813 of the analysis chip 810 in the seventh embodiment.

A micro lens for magnifying is preferably placed on the channel 821. The illuminating tool for emitting the light to the channel 821 is further preferably placed.

FIG. 22B is a sectional view when the analysis chip 820 is viewed from the side. A first metal foil 827, a nylon mesh 828 and a second metal foil 829 are laminated on the substrate 825. The first metal foil 827 and the second metal foil 829 are the metals whose kinds are different. For example, the first metal foil is copper, and the second metal foil is zinc. A part of the nylon mesh 828 is exposed to the electrolyte introduction port 826.

The analysis chip 820 having such configuration can be manufactured by making the plastic chip as second-layer structure, and laminating the first metal foil 827, the nylon mesh 828 and the second metal foil 829 on the empty portion formed on the plastic chip in a low layer, and then pasting the plastic chip in an upper layer thereon.

Electrodes 830 made of palladium are placed at both ends of the channel 821. Each of the electrodes 830 at both of the ends is connected to the first metal foil 827 and the second metal foil 829.

The analysis chip 820 is used as follows. At an initial state, the bead 822 is tentatively fixed to the tentative fixer 823. The solution is introduced from the introduction port (not shown) placed at one end of the channel 821. The solution flows through the channel 821. The viscosity of the polymer solution 827 is changed depending on the concentration of the particular substance contained in the solution.

A user of the analysis chip 820 introduces electrolyte into the electrolyte introduction port 826. The electrolyte is developed along the nylon mesh 828 by capillary phenomenon or the like. The first metal foil 827, the nylon mesh 828 containing the electrolyte, and the second metal foil 828 constitute a battery of a Volta type. A potential difference is generated between the electrodes 830 at both of the ends of the channel 830.

The generated potential difference causes the bead 822 to move in the channel 821. The movement speed of the bead 822 is dependent with the viscosity of the polymer solution 827. By measuring the moving distance of the bead 822 in a certain time, the viscosity of the polymer solution 827 is quantitatively measured. Or, by measuring the time until the bead 822 arrives at a predetermined position, the viscosity of the polymer solution 827 is quantitatively measured. From the measured viscosity of the polymer solution 827, a concentration of the particular substance contained in the solution is known.

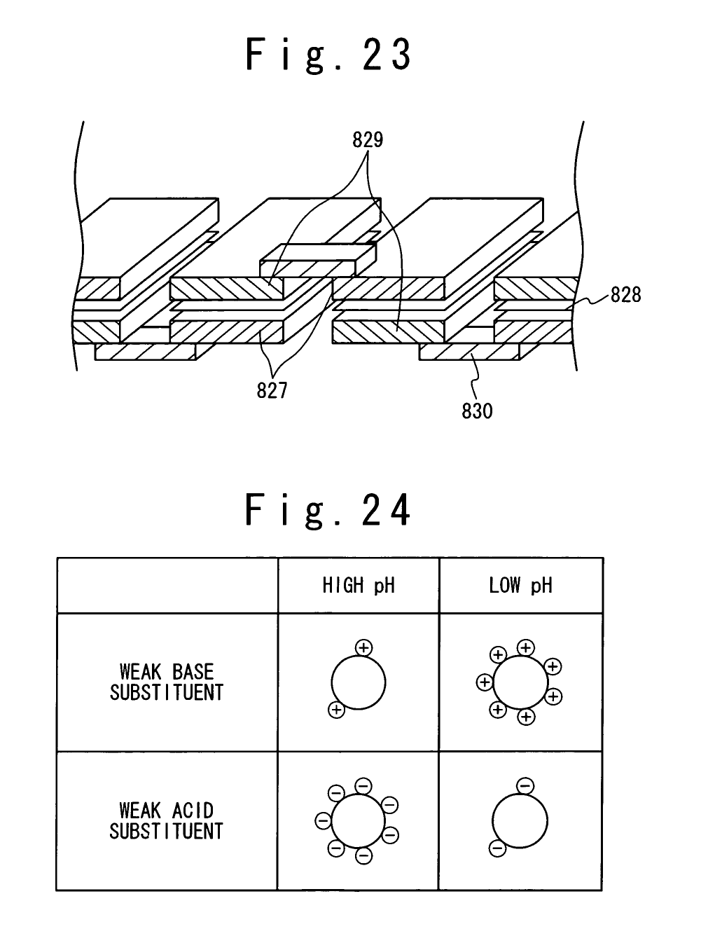

If the first metal foil 827 is copper and the second metal foil 829 is zinc, an electromotive force is about 0.7 Volts. In order to drive the bead 822 made of the light plastic, the potential difference of about 7 volts is preferred to exist between the electrodes 830 at both the ends. By connecting the 10 stages of the Volta type batteries in series, the voltage of about 7 volts can be obtained. With reference to FIG. 23, the structure in which the Volta type batteries are wired in series is shown. The 10 Volta type batteries in which the first metal foils 827, the nylon meshes 828 and the second metal foils 829 are laminated are placed, and the sides are arrayed so as to be adjacent to each other through an insulating layer (not shown). In the Volta type batteries adjacent to each other, the order of the lamination of the first metal foil 827 and second metal foil 829 is opposite. The first metal foil 827 of one Volta type battery and the second metal foil 829 of the Volta type battery adjacent thereto are electrically connected through the conductive member 830. Due to the wiring, the Volta type batteries connected in series are formed in the substrate 825 so that the potential difference of about 7 volts can be obtained between the electrodes 830 at both the ends.

As a variation of this embodiment, an analysis chip using a polymer bead having many exchanger groups is possible. The analysis chip in this variation does not always require the polymer solution 827 whose viscosity is changed in reaction with the particular substance, in the analysis chip 820 shown in FIG. 22A and FIG. 22B. Moreover, the bead 822 shown in FIG. 22A and FIG. 22B is made of the polymer having many residues of acid or base such as ion exchange resin. In the bead 822, a part of the residues is ionized on the basis of the pH of the solution, and the remainder becomes at the non-ionized state. Thus, surface charges are changed depending on the pH of the solution. The other configuration is equal to the analysis chip 820 shown in FIG. 22A and FIG. 22B.

The change in the surface charge of the bead 822 depending on the change of the pH of the solution is shown in FIG. 24. If the bead 822 is made of the polymer having many weak base substituents, in the solution having high pH, the bead 822 has a small positive surface charge. In the solution having the low pH, the bead 822 has a larger positive surface charge. If the bead 822 is made of the polymer having many weak acid substituents, in the solution having high pH, the bead 822 has a large negative surface charge. In the solution having low pH, the bead 822 has a smaller negative surface charge.

Thus, the bead 822 becomes the surface charge corresponding to the pH in a certain pH range, by selecting the polymer having a proper ion exchange property. So, when a potential difference is applied between the electrodes 830 of both the ends of the channel 821, the bead 822 receives the force proportional to the surface charge. Thus, the movement speed of the bead 822 is changed depending on the surface charge. By detecting the change of the movement speed of this bead 822, the pH change is measured. Then the quantitative information with regard to the amount of the component targeted is visually obtained.

### Ninth Embodiment

An analysis chip in the ninth embodiment is attained by using the reaction of the kind, where even if there is a sufficient reagent, if a concentration of a sample is insufficient, the reaction does not occur. For example, a plurality of reacting baths for an enzyme immunity measurement (ELISA) on which antigens of a predetermined amount are coated are arranged in the shape of array. Then, when the samples in which the dilution magnifications of antibodies are different are introduced to them, the colorization reaction does not appear in the samples at all, in which the dilution magnifications are equal to or higher than a certain value. Thus, the reacting bath arrays are arranged in the order of the dilution magnifications of the samples. Then, by observing the portion of the reacting bath arrays where the presence or absence of the colorization is changed, the concentration of the antibody in the sample can be quantitatively detected.

Similarly, when a concentration of an enzyme (for example, AST) in serum is measured, a plurality of reacting baths, each of which includes the reagent of the same amount that generates a color if there is the AST, are arranged in the shape of array. When the serums having different dilution magnifications are introduced into the respective reacting baths, the color generation does not appear in the reacting baths at all, where the serums having a certain dilution magnification or more are introduced.

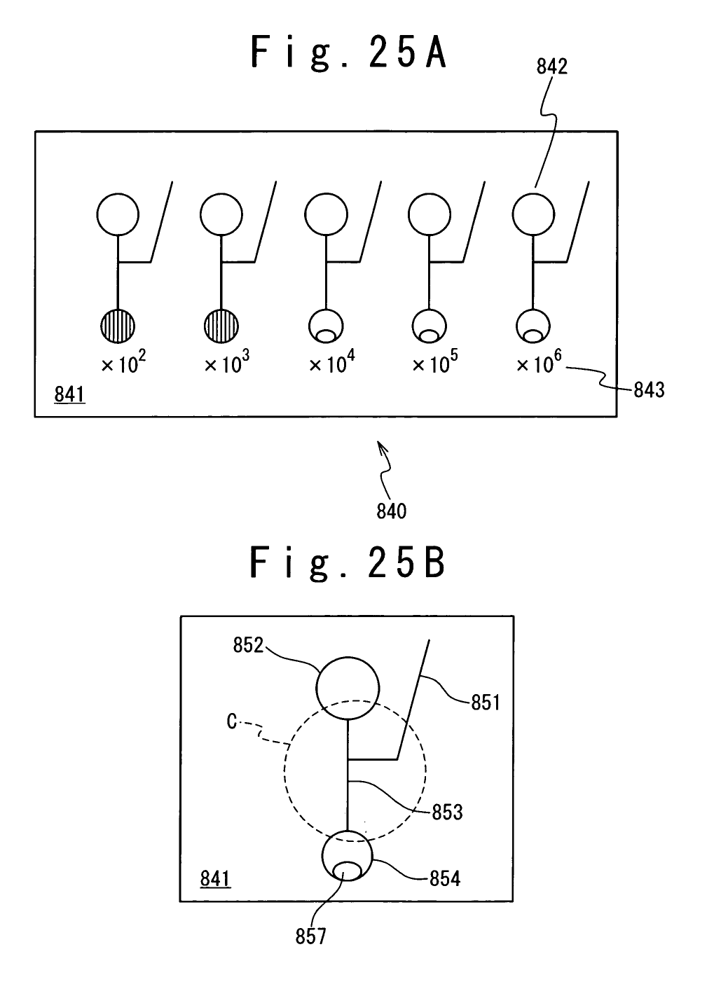

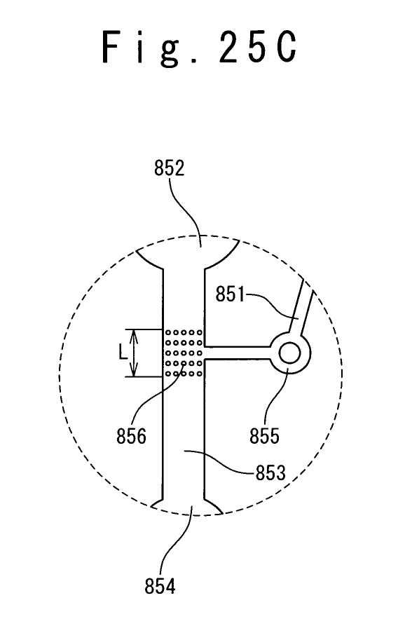

By using such a mechanism, the analysis chip can be attained in which the concentration of the sample can be measured quantitatively by naked eyes. The configuration of the analysis chip 840 is shown in FIG. 25A. The analysis chip 840 includes a substrate 841. A plurality of reacting units 842 are arranged in the shape of array in the substrate 841. Correspondingly to each of the reacting units 842, a dilution magnification 843 is written on the substrate 841.

The configuration of the analysis chip 840 is shown in FIG. 25B. The reacting unit 842 has a sample introduction path 851 formed on the substrate 841. The reacting unit 842 further has a reagent introduction path 853 formed on the substrate 841. One end of the sample introduction path 851 opens in the reagent introduction path 853.

The reacting unit 842 further has a reagent introduction port 852 and a reacting bath 854 formed on the substrate 841. An air hole 857 is formed in the reacting bath 854. One end of the reagent introduction path 853 opens in the reagent introduction port 852. The other end of the reagent introduction path 853 opens in the reacting bath 854.

The detailed configuration of the portion surrounded with a dotted line in FIG. 25B is shown in FIG. 25C. A backflow protection valve 855 is placed in the middle of the sample introduction path 851. A hydrophilic polymer bead whose volume is increased by water absorption is placed in the backflow protection valve 855.

In the reagent introduction path 853, a sample holder 856 is formed in the vicinity crossing the sample introduction path 851. In the sample holder 856, many thin pillars are formed, or many thin grooves are formed. The surface of the sample holder 856 is hydrophilic. The sample holder 856 has a length L along the direction of the extension of the sample introduction path 851. The sample holder 856 holds the solution of the amount proportional to the length L, through the capillary effect, and suppresses the solution from oozing out to the outside of the sample holder 856.

Again with reference to FIG. 25A, in each of the plurality of reacting units 842 of the analysis chip 840, the length L of the sample holder 856 is different. As compared with the length L of the reacting unit 842 on the rightmost side in FIG. 25A, the length L of the second reacting unit 842 from the right side is 10 times. As compared with the length L of the second reacting unit 842 from the right side of FIG. 25A, the length L of the third reacting unit 842 from the right side is ten times. Hereafter, the relation of lengths are similar.

A micro lens for magnifying is preferably placed on the reagent introduction path 853. The illuminating tool for emitting the light to the reagent introduction path 853 is further preferably placed.

The analysis chip 840 having the configuration is used as follows. The sample solution is introduced from the sample introduction paths 851 to the respective reacting units 842 of the analysis chip 840. The introduction is carried out by using the capillary attraction force of the sample introduction path 851 or sample holder 856. When the sample holder 856 includes the sample of a predetermined amount, the introduction through the capillary attraction force is automatically stopped. The introduced sample is held in the sample holder 856.

The amount of the held sample is proportional to the length L of the sample holder 856. Thus, each of the plurality of reacting units 842 shown in FIG. 25A, as it is closer to the left side, holds larger amount of sample in the sample holder 856.

When the sample is introduced, the hydrophilic polymer bead filled in the backflow protection valve 855 is swelled, which clogs the sample introduction path 851. Thus, the processes on and after this protects the solution from flowing into a sample introduction path 1 from a reagent introduction path 3.

The reagent solution is forced to be introduced from the reagent introduction port 852. The air in the reagent introduction path 853 pushed by the reagent solution is pushed out from the air hole 857. The reagent solution, while pushing out the sample held in the sample holder 856, flows through the reagent introduction path 3 into the reacting bath 854. Since the size of the air hole 857 is small, if the reagent solution containing the sample blocks the air hole 857, it becomes difficult to introduce the reagent solution moreover into the reagent introduction path 853.

The mixed solution of the reagent solution and the sample stays inside the reacting bath 854. Since the lengths L of the respective sample holders 856 of the plurality of reacting units 842 are different, the dilution magnifications of the samples in the reacting bath 854 are different in the respective reacting units 842. On the analysis chip 820, the dilution magnification 843 is written to the position corresponding to each of the reacting units 842. The dilution magnifications 843 are, for example, 10² times, 10³ times, 10⁴ times, 10⁵ times and 10⁶ times, sequentially from the reacting unit 842 on the left end.

The reagent reacts with the particular component included in the sample and generates the colorization reaction. The colorization reaction ends after a certain period. When the reaction ends, in the analysis chip 840, it is recognized that the reacting bath 854 of the reacting unit 842 whose dilution magnification is low is colored and the reacting bath 854 of the reacting unit 842 whose dilution magnification is high is not colored by naked eyes. For example, it is recognized that the reacting bath 854 of the reacting unit 842 whose dilution magnification is 10³ or more is colored and the reacting bath 854 of the reacting unit 842 whose dilution magnification is 10⁴ or more is not colored by naked eyes. The concentration of the sample is quantitatively known by visually recognizing to which position the reacting unit 842 is colored among the reacting units 842 arranged in the shape of the array in the analysis chip 840.

Such an analysis chip 840 is preferably used in the case that it is represented by the disconnected values of 100 times, 1000 times, 10000 times and the like, such as the antibody titer of an infectious disease.

### Tenth Embodiment

An analysis chip in the tenth embodiment is configured so as to be able to check the presence or absence of the solution in the channel easily by naked eye, without mixing a dye into the solution.

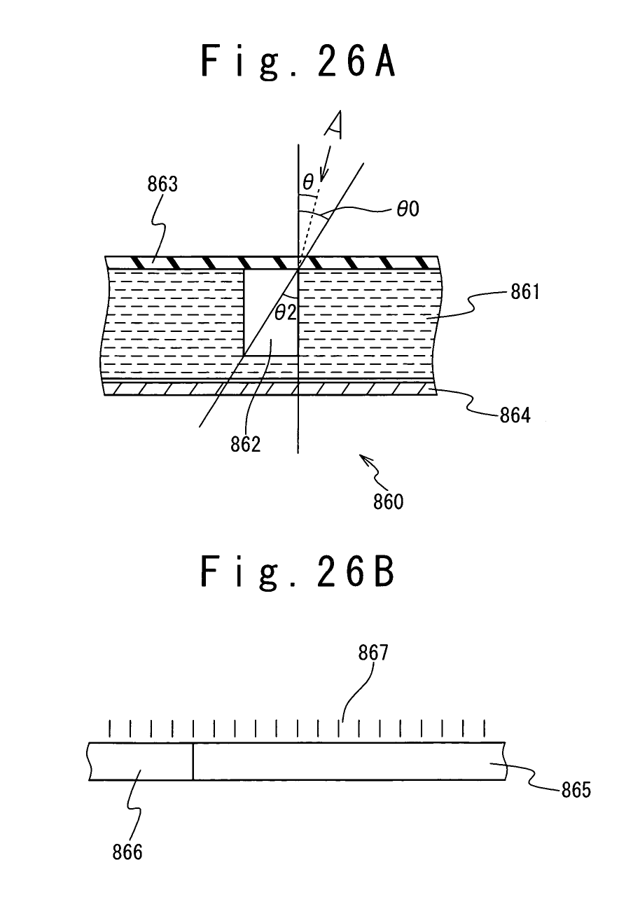

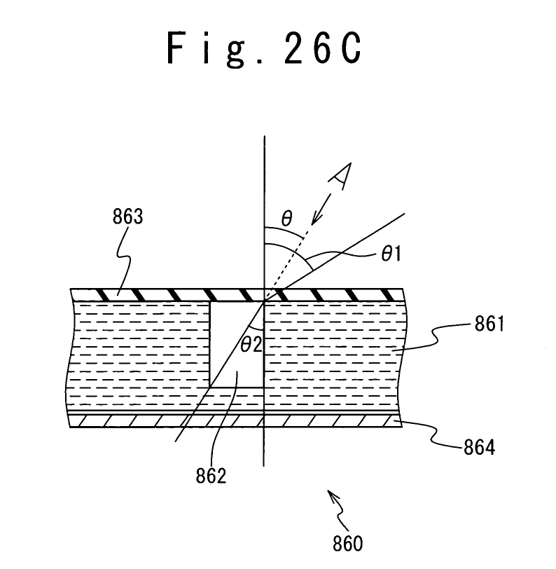

A sectional view of the analysis chip is shown in FIG. 26A. An analysis chip 860 includes a substrate 861. The substrate 861 is made of the transparent material exemplified as glass. A channel 862 is formed on the substrate 861. The bottom surface of the substrate 861 is covered with a foil 864. The top surface of the substrate 861 is covered with a cover 863. The cover 863 is made of a transparent material.

A micro lens for magnifying is preferably placed on the channel 862. The illuminating tool for emitting the light to the channel 862 is further preferably placed.

With reference to FIG. 26A, a oblique auxiliary line is drawn which connects a corner angle portion on which a bottom surface and a side of the channel 862 contacts and a top end point of the other side. The angle between this auxiliary line and the line vertical to the surface of the substrate 861 is represented by θ₂.

The analysis chip having such configuration is used as follows.

With reference to FIG. 26A, the angle between a visual line when a user of the analysis chip 860 views the channel 862 and the line vertical to the surface of the substrate 861 is represented by θ. If 0<θ<θ (the θ is the value determined by the shape and material of the analysis chip, and in this case, θ₀≈θ₂), the user can view the foil 864 through the bottom surface of the channel 862. Thus, the channel 862 seems to be bright. On the other hand, if θ>θ₀, the user can view the bottom surface of the remote substrate 861 or the side of the analysis chip 860 through the wall surface of the channel 862. Thus, the channel 862 seems to be dark. This is because since the substrate 861 has a refractive index higher than air or water, the optical path extending from the side of the channel 862 to the inside of the substrate 861 extends at an angle smaller than an incident angle to the wall surface, namely, at an angle nearer to parallel to the bottom surface of the substrate 861.

With reference to FIG. 26B, the analysis chip 860 when the channel 862 is filled with the solution is shown. The angle between the visual line when the user of the analysis chip 860 views the channel 862 and the line vertical to the surface of the substrate 861 is represented by θ. If 0<θ<θ, the user can view the foil 864 through the bottom surface of the channel 862. Thus, the channel 862 seems to be bright. Since the refractive index of the solution is higher than the air as exemplified in the water (whose refractive index is 1.333), θ₁<θ₀. That is, if the channel 862 is filled with the solution, as compared with the case that the channel 862 is filled with the air, the angle range when the foil 864 is viewed through the bottom surface of the channel 862 is wide.

With reference to FIG. 26C, the top view of the analysis chip 860 in which a part of the channel 862 is filled with the solution and there is no solution in the other portion is shown. If the user views the channel 862 from the angle θ₀ satisfying θ₀<θ<θ, a portion 865 filled with the solution seems to be bright because the foil is viewed through the bottom surface of the channel 862, and a portion 866 having no solution seems to be darker. By reading the boundary between the bright portion and the dark portion from a scale 867, it is possible to visually recognize to which portion the channel 862 is filled with the solution.

In order to easily attain the recognition by naked eyes, the difference between θ₀ and θ₁ is preferred to be larger. Thus, the shape of the channel 862 is preferably formed such that the difference between θ₀ and θ is larger by using the following method.

When a refractive index of the air is n₁ and a refractive index of the solution in the channel is n₂, the Snell's law represented by the following equation is given;
n₂ sin θ₂=n₁ sin θ₁ (1)

Thus, a difference Δθ between θ₀ (≈θ₂) and θ₁ is represented by the following equation;
Δθ=sin⁻¹(n₂/n₁ sin θ₂)−θ₂. (2)

The Δθ has the maximum value when the following equation is true;
n₂/n₁ sin θ₂=1. (3)

The Δθ indicates the range of the angle in which the portion of the channel including the solution seems to be bright and the portion having no solution seems to be dark. Thus, in order to improve the visibility of the solution, preferably, θ is set so as to make the Δθ larger. In particular, in the analysis chip in which the particular solution is targeted for the analysis, preferably, the refractive index n₂ of the solution is used to determine θ₂ so as to make the Δθ larger.

As an example, when the solution in the channel is water (whose refractive index is 1.333) and n₁=1 and n₂=1.333 are substituted, at a time of θ₂48.6 degrees, the Δθ has the maximum value 41.4. Thus, when a rectangular channel where the angle between the line connecting the corner of the bottom surface and the top end of the wall surface opposite thereto and the perpendicular is 48.6 degree on the section of the channel is formed on the channel, the presence or absence of the water in the channel (or the solution whose refractive index is close to the water) can be visually recognized from the wide angle, under the best visibility.

According to the analysis chip, without mixing the dye for the easy recognition into the solution, it is possible to easily recognize whether or not the solution exists in the solution or recognize to which position the solution exists in the channel. According to the analysis chip 860, even if it is not preferred to mix the dye in the reaction solution, without any operation to mix the dye into the solution after the reaction, the visual recognition of the solution can be easily executed.

A variation of this embodiment will be described below. An analysis chip in this variation does not always require the foil 864, in the configuration of the analysis chip 860 shown in FIG. 26A. Moreover, the wall surface of the channel 862 is made of the material whose refractive index is equal to or less than the water.

The analysis chip of the configuration is used as follows. If the channel 862 is made of the material whose refractive index is lower than the water, when the channel 862 is filled with the water solution, this leads to the relation of the refractive index in which the water corresponds to a core of an optical fiber, and the channel corresponds to a clad. Thus, depending on the direction of the observation of the channel 862, the total reflection occurs on the boundary between the surface of the channel and the water solution. Hence, the channel portion including the water solution seems to be bright as compared with the portion having no water solution.

If a refractive index n₁ of a material on the side to which the light is inputted is higher than a refractive index n₂ of a material on the output side, a refractive angle θ on the output side exceeds 90 degrees if □₁ is higher than a certain angle in accordance with the Snell's law represented by the following equation;
sin θ₂=n₂/n₁ sin θ₁ (4)

When θ is in this range, the total reflection occurs. Thus, the channel 862 seems to be bright.

If the periphery of the channel 862 is made of the material whose refractive index is equal to the water, by mixing the refractive index increasing substance into the solution, the same effect as the above case is achieved. As the refractive index increasing substance, cane sugar, carboxy cellulose, and polyvinyl alcohol are exemplified.

Teflon-based resin is exemplified as the material used to form a channel 873, in which the refractive index is equal to or less than the water. The Teflon-based resin is used as the material of the clad of the optical fiber. If the difference of the refractive index between the clad and the center (core) of the fiber whose refractive index is higher is large, this is preferred because the light loss becomes small. Thus, the development of the Teflon-based resin whose refractive index is lower is advanced. Currently, the material whose refractive index is about 1.38 is developed. There is a high possibility that the material having the lower refractive index will be developed in future.

According to the analysis chip, even if the mixture of the dye into the reacting solution is not preferable, without any operation to mix the dye into the solution after the reaction, the visual recognition of the solution can be easily executed.

### Eleventh Embodiment

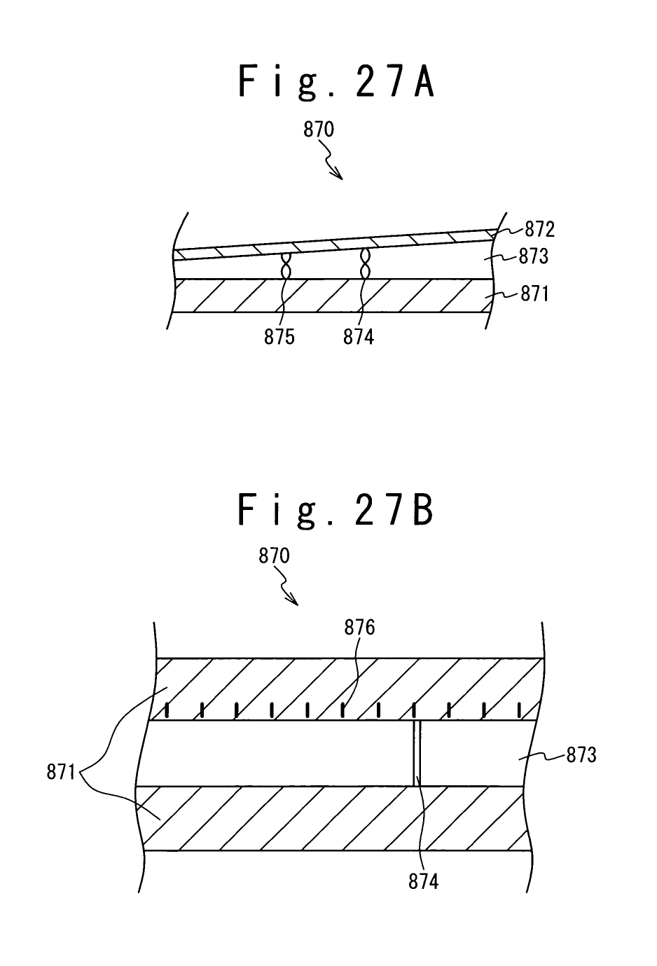

The sectional view when an analysis chip in the eleventh embodiment is viewed from the side is shown in FIG. 27A. An analysis chip 870 includes a substrate 871. A channel 873 is placed in the substrate 871. The height of the channel 873 in the direction vertical to the substrate 871 corresponds to several wavelengths (an order of 10⁻⁶ m) of a wavelength of a visible light. The channel 873 is covered with a transparent cover 872. In the channel 873, the height in the direction vertical to the substrate 871 is continuously changed in the extension direction of the channel 873. The change in the height of the channel 873 as mentioned above is attained by placing a spacer having a proper thickness (several microns) at one end of the cover 872, for example, when the cover 872 is placed for the substrate 871.

A micro lens for magnifying is preferably placed on the channel 873. The illuminating tool for emitting the light to the channel 873 is further preferably placed.

The analysis chip 870 having such configuration is used as follows.

When the user views the channel 873 from above the cover 872, the lights interfere with each other in the space sandwiched between the bottom surface of the channel and the cover 872 covering the upper portion of the channel. Thus, as shown in FIG. 27B, the user views an interference stripe 874. For example, a bright stripe occurs in a portion 874 where the lights strengthen each other between the bottom surface of the channel and the cover 872 covering the upper portion of the channel, and a dark stripe occurs in a portion 875 where the lights weaken each other.

Since the height of the channel 873 is changed in the extension direction of the channel 873, the position at which the interference stripe 874 is viewed is changed depending on the refractive index of the substance filled in the channel 873. For example, if the solution whose refractive index is higher is filled in the channel 873, the wavelength of the light becomes slightly short. Thus, the position of the interference stripe 874 moves to the portion in which the height of the channel 873 is low, namely, the left direction of the drawing. On the contrary, if the solution whose refractive index is lower is filled in the channel 873, the wavelength of the light becomes slightly longer. Hence, the position of the interference stripe 874 moves to the portion in which the height of the channel 873 is higher, namely, the right direction of the drawing.

Therefore, by reading the position of the interference stripe 874 from a scale 876, the refractive index of the solution filled in the channel 873 can be visually recognized.

According to the analysis chip 870, the concentration of the solution containing biopolymer can be visually measured. This is because the solution containing the biopolymer and the like has the higher refractive index, as the concentration is higher, and the concentration of the solution can be consequently known from the position of the interference stripe 874.

1-40. (canceled)

41. An analysis chip comprising:
a substrate on which a channel is formed,
a sensing element placed in a part of said channel and in which a reagent which generates a change in appearance in a chemical reaction with a particular substance is uniformly distributed; and a scale which is placed along said sensing element.

42. The analysis chip according to claim 41, further comprising:
a lens covering said sensing element,
wherein an area of a surface of said substrate on which said channel is formed other than areas where said channel is formed is made of an opaque material.

43. The analysis chip according to claim 42, further comprising:
a reagent separator separating a large particle and a smaller particle included in a liquid flowing in said channel into a second channel.

44. The analysis chip according to claim 43, wherein said channel and said second channel is separated by a barrier having a hole which is smaller than said large particle, and
a surface of said barrier includes a hydrophobic material.

45. The analysis chip according to claim 42, wherein said channel is a rectangular groove and when a section vertical to a flow direction of said channel is seen, an angle of a edge of a bottom surface of a channel and a top on an opposite side is approximately 48.6 degrees.

46. The analysis chip according to claim 43, further comprising:
a first illumination member emitting light from an undersurface of said channel; and
a magnifier magnifying an inside of said channel.

47. The analysis chip according to claim 41, further comprising:
a reagent bead covered with different reagents to form a multilayer coating.

48. The analysis chip according to claim 47, further comprising:
a reagent separator separating a large particle and a smaller particle included in a liquid flowing in said channel into a second channel.

49. The analysis chip according to claim 48, wherein said channel and said second channel is separated by a barrier having a hole which is smaller than said large particle, and
a surface of said barrier includes a hydrophobic material.

50. The analysis chip according to claim 47, wherein said channel is a rectangular groove and when a section vertical to a flow direction of said channel is seen, an angle of a edge of a bottom surface of a channel and a top on an opposite side is approximately 48.6 degrees.

51. The analysis chip according to claim 47, further comprising:
a first illumination member emitting light from an undersurface of said channel; and
a magnifier magnifying an inside of said channel.

52. The analysis chip according to claim 47, wherein said sensing element includes a reagent in which an appearance is changed by a reaction with said particular substance.

53. The analysis chip according to claim 52, wherein said reagent is uniformly distributed in said sensing element.

54. The analysis chip according to claim 41, further comprising:
a hue pattern placed in adjacent to said channel and a lengthwise size of which being same to said sensing element.

55. The analysis chip according to claim 54, wherein a groove adjacent to said channel and parallel to said channel is formed on said substrate, and
said hue pattern is formed inside said groove.

56. The analysis chip according to claim 54, further comprising:
a reagent separator separating a large particle and a smaller particle included in a liquid flowing in said channel into a second channel.

57. The analysis chip according to claim 56, wherein said channel and said second channel is separated by a barrier having a hole which is smaller than said large particle, and
a surface of said barrier includes a hydrophobic material.

58. The analysis chip according to claim 54, wherein said channel is a rectangular groove and when a section vertical to a flow direction of said channel is seen, an angle of a edge of a bottom surface of a channel and a top on an opposite side is approximately 48.6 degrees.

59. The analysis chip according to claim 54, further comprising:
a first illumination member emitting light from an undersurface of said channel; and
a magnifier magnifying an inside of said channel.

60. The analysis chip according to claim 54, wherein said sensing element includes a reagent in which an appearance is changed by a reaction with said particular substance.

61. The analysis chip according to claim 60, wherein said reagent is uniformly distributed in said sensing element.

62. The analysis chip according to claim 41, wherein said reagent includes at least one member selected from the group consisting of an enzyme, an antibody, an antigen and a fluorescent material.

63. The analysis chip according to claim 62, further comprising:
a reactor which is formed on said channel and in which an indication substance to be specifically coupled to a particular component is placed; and
a catcher which is formed on a downstream side from said reactor of said channel and catches said indication substance coupled to said particular component.

64. The analysis chip according to claim 62, wherein a width of said channel of a region where said catcher of said channel is formed is gradually narrowed toward an advancement direction of said channel.

65. The analysis chip according to claim 63, wherein a density of said indication substance in said catcher is higher toward a downstream side of said channel.

66. The analysis chip according to claim 41, wherein said channel gradually narrows toward a downstream side, and
a hydro-gel layer whose volume is changed when said particular substance is absorbed is placed on a wall surface of said channel, and
said change in appearance is occurred by a closing of said channel at a different position depending on an amount of said particular component because a volume of said hydro-gel layer is changed when colored said particular component flows in said channel.

67. The analysis chip according to claim 41, further comprising:
a bead placed in said channel and whose surface is formed by a hydro-gel layer whose volume is changed when absorbing said particular component,
wherein said channel gradually narrows toward a downstream side is placed, and
said change in appearance is occurred when a liquid flows in said channel and said bead is carried away by said liquid and stopped at a different position in said channel depending on a volume.

68. The analysis chip according to claim 41, further comprising;
a polymer solution placed inside said channel in which a reaction with said particular substance changes a viscosity of said polymer,
a target bead placed inside said channel; and
a tentative holder that is placed at a predetermined position inside said channel and holds said target bead at said predetermined position when a force weaker than a predetermined magnitude is applied to said target bead.

69. The analysis chip according to claim 68, wherein said target bead includes a ferromagnetic material.

70. The analysis chip according to claim 68, further comprising;
a pair of electrodes formed at ends of said channel, and
a battery which generates a potential difference between said pair of electrodes,
wherein a surface of said target bead is charged in a solution of a predetermined pH.

71. The analysis chip according to claim 41, wherein said channel includes;
a solution holder which contains a solution through capillary attraction; and
an introduction path which introduces a solution into said solution holder through capillary attraction.

72. The analysis chip according to claim 71,
wherein said analysis chip comprises a plurality of said channels, and
a plurality of said solution holders each of which is included in each of said plurality of channels hold a different amount of solution each other.

73. The analysis chip according to claim 41,
wherein said channel is a rectangular groove formed on a surface side of said substrate, and
further comprising a reflector that is placed along a bottom surface of said substrate and reflects a visible light.

74. The analysis chip according to claim 41,
wherein a wall surface of said channel is covered with a material whose refractive index is equal to or less than a refractive index of water.

75. The analysis chip according to claim 41, further comprising;
a transparent cover covering said channel,
wherein a distance between a bottom surface of said channel and said cover is continuously changed in an lengthwise direction of said channel, and
an interference band whose position is different depending on a refractive index of a substance filled in said channel is displayed on an outer side of said cover by reflection of light between said bottom surface and said cover.

76. The analysis chip according to claim 63, wherein said particular component is a first antibody, and
said indication substance is a second antibody.

77. An analyzing apparatus comprising:
a substrate on which a channel is formed,
a sensing element placed in a part of said channel and in which a reagent which generates a change in appearance in a chemical reaction with a particular substance is uniformly distributed,
a scale which is placed along said sensing element; and
a second illumination member emitting light to said sensing element from a side face of said analysis chip.

78. The analyzing apparatus according to claim 77, wherein said light which said second illumination member emits to said sensing element is ultraviolet light.

79. The analyzing apparatus according to claim 77, wherein said second illumination member includes a light collecting lens collecting light to said sensing element.

80. The analyzing apparatus according to claim 77, wherein said second illumination member is a light emitting member.

81. The analyzing apparatus according to claim 77, wherein said illumination member is any of a bulb, LED and black light.

82. The analyzing apparatus according to claim 77, wherein said second illumination member has a mounting part on which a side face of said substrate is mounted, and
when said substrate is mounted to said second illumination member, said second illumination member collects natural light and supplies light being approximately parallel to a substrate surface of said substrate to said substrate.
